(19) United States
(12) Patent Application Publication
(10) Pub. No.: US 2008/0158248 A1
(43) Pub. Date: Jul. 3, 2008

(54) Rendering device and rendering method

(75) Inventors: Yasuo Nishioka, Osaka (JP); Tetsuji Kishi, Osaka (JP); Seiji Horii, Osaka (JP); Yuji Takai, Osaka (JP); Daisuke Murakami, Kyoto (JP); Yuki Soga, Kyoto (JP)

Correspondence Address: MCDERMOTT WILL & EMERY LLP, 600 13TH STREET, NW, WASHINGTON, DC, 20005-3096, US

(73) Assignee: MATSUSHITA ELECTRIC INDUSTRIAL CO., LTD., Osaka (JP)

(21) Appl. No.: 12/071,941

(22) Filed: Feb. 28, 2008

Related U.S. Application Data
(62) Division of application No. 11/037,244, filed on Jan. 19, 2005.

(30) Foreign Application Priority Data
Jan. 20, 2004 (JP) P2004-12290

(51) Int. Cl. G09G 5/00; G06T 11/20

(52) U.S. Cl. 345/606; 345/442

(57) ABSTRACT

A rendering device according to the present invention comprises an information acquiring unit for acquiring system information or rendering object information, a control point generating section for setting a curved surface interpolating level serving to determine number of control points for creating a curved surface or a curved line based on the acquired information and thereby generating the control point in accordance with the curved surface interpolating level, and a curved surface creating section for creating the curved surface based on the control point, wherein an operation quantity for rendering the curved surface of a display object is dynamically changed based on the acquired information.

### BACKGROUND OF THE INVENTION

1. Field of the Invention

The present invention relates to a rendering device and a rendering method.

2. Description of the Related Art

As an example of a method for rendering a free curved surface/free curved line in a virtual three-dimensional space (or virtual two-dimensional space), a method for employing a parametric curved-line in which a control point is used, such as Bezier curve and spline curve, is generally known. The free curved line is created in the form of an n-dimensional graph in which the control point serves as a constitutional point or a point on a tangential line. In the creation of the free curved surface/free curved line utilizing the parametric line, the free curved surface/free curved line which are more elaborate can be created as the number of the control points is increased, though an increased number of control points results in an increased operation quantity required for the creation of the free curved surface/free curved line.

In a system designed to display three-dimensional graphics and to reproduce a moving picture, a screen renewal cycle is set in accordance with performances of a rendering device and a display unit, and data used for rendering an image is necessarily created within the screen renewal cycle and transmitted to the display unit. As an index indicating how many times the screen is rewritten per second is generally known a frame rate. For example, when the frame rate is 30 fps, the image is rendered 30 times per second.

When the free curved surface/free curved line is rendered in a rendering device in which the screen renewal cycle is set, it is necessary to complete an operation for the image creation with respect to a predetermined region, a writing process with respect to a frame buffer, and data transmission to the display unit within the screen renewal cycle. When a large number of control points are used for a highly precise rendering, the operation quantity increases, as a result of which the successive rendering-related processes may not be completed within the screen renewal cycle. On the other hand, when a reduced number of control points are generated with respect to a rendering object, the operation quantity can be successfully reduced, while an image data lacking in elaborateness as an image is constantly created, which possibly undermines a user's satisfaction.

Examples of conventional efforts for changing the operation quantity are listed below.

According to a conventional technology 1 (No. 2001-250128 of the Publication of the Unexamined Japanese Patent Applications), a method in which the number of divisions is changed in accordance with a distance between a point selected from control points of a display object or a representative point of the control points of the display object and an eye point, and a method in which the number of the divisions is changed in accordance with a distance between a point selected from constitutional points of a simplified object of the display object or a representative point of the constitutional points of the simplified object and the eye point, are adopted. In the foregoing methods, the number of the divisions in the display object distant from the eye point is reduced so as to thereby reduce the operation quantity in the rendering process.

According to a conventional technology 2 (No. 2002-183745 of the Publication of the Unexamined Japanese Patent Applications), at least one of a model to be used, necessity/omission of rendering the object and a content of the rendering is changed when at least one of the following situations occurs: the change of the screen renewal cycle; pause direction; and slow direction. In the foregoing manner, a rendering process which may provide a degraded image quality but can assure a high-speed process can be performed so that the rendering can be unfailingly completed within the screen renewal cycle in the case of an ordinary rendering renewal cycle while a high-quality image can be rendered though it takes some time in the case of a longer rendering renewal cycle.

To describe potential problems in those conventional technologies, in the conventional technology 1, the operation quantity is reduced in compliance with the distance between the rendering object and the eye point. However, because the operation quantity is reduced based on the distance relative to the eye point, it is not possible for the operation quantity to be reduced when the display object is in close vicinity of the eye point. Therefore, there is a risk that the rendering process may not be completed within the screen renewal cycle when a large number of rendering objects, in which the distance from the display object to the eye point is shorter, are rendered. As another risk, the rendering process may not be completed within the screen renewal cycle due to system statuses of the rendering device because the operation quantity is not affected by the operation performance and system statuses of the rendering device.

In the conventional technology 2, the operation quantity is changed in response to the change of the rendering renewal cycle, however, the rendering process may not be completed due to any system status other than the screen renewal cycle because any system status other than the rendering renewal cycle is not included in considerations. Further, when the control points are generated in pursuit of reducing the operation quantity for the free curved surface/free curved line so that the rendering process can be completed in time before the screen renewal cycle is over, a created image results in a lower precision. In such a case, the rendering can only be performed with a high precision when the rendering renewal cycle satisfies given conditions.

In the conventional technology 2, the operation quantity is changed in response to the change of the rendering renewal cycle, however, the image of the graded quality is constantly generated in the ordinary rendering renewal cycle in which neither of the pause direction nor the slow direction is occurring.

### BRIEF SUMMARY OF THE INVENTION

A rendering device according to the present invention comprises:

an information acquiring unit for acquiring system information or rendering object information;

a control point generating section for setting a curved surface interpolating level serving to determine the number of control points for creating a curved surface or a curved line based on the acquired information and thereby generating the control point in accordance with the curved surface interpolating level; and

a curved surface creating section for creating the curved surface based on the control point, and is adapted to dynamically change an operation quantity for rendering a curved surface of a display object based on the acquired information. The control point generating section and the curved surface creating section constitute a rendering unit, which is a block for performing a rendering process.

The system information is at least one of a remaining battery level, a clock gear ratio of the rendering device, an allocated band width of the rendering device with respect to a memory unit, a bus traffic quantity of an interconnection network, a network traffic quantity of a network, an interruption frequency with respect to the rendering device and the like. The rendering object information is at least one of moving-speed information of a created rendering object, display area information of the rendering object, distance information between the rendering object and an object of attention, numeral information of the rendering object, size information of the rendering object, displayed period information of the rendering object, image quality information of a display unit and the like.

According to the rendering device constituted as above, a free curved surface/free curved line can be created with an optimum rendering quality in response to statuses of the rendering object and system. The optimum rendering quality denotes a rendering quality of a highest precision that can be achieved by the rendering process completed within a screen renewal cycle or a rendering quality that can comply with views of a producer or a user of the rendering device.

A rendering device according to the present invention comprises:

a system information acquiring unit for acquiring system information;

a control point generating section for setting a curved surface interpolating level serving to determine the number of control points for creating a curved surface or a curved line based on the system information and thereby generating the control point in accordance with the curved surface interpolating level; and

a curved surface creating section for creating the curved surface based on the control point and is adapted to dynamically change an operation quantity for rendering a curved surface of a display object based on the system information. The control point generating section and the curved surface creating section constitute a rendering unit, which is a block for performing a rendering process. The control point generating section changes the number of the control points used for the creation of the free curved surface/free curved line in accordance with the acquired system information and thereby changes the operation quantity required for the creation of the free curved surface/free curved line, which are created by the curved surface creating section.

In a rendering method according to the present invention, which corresponds to the foregoing rendering device, the system information is acquired, the curved surface interpolating level for creating the curved surface or curved line is determined based on the system information and the control point is thereby generated. Then, the curved surface is created based on the control point. The operation quantity for rendering the curved surface of the display object is accordingly dynamically changed based on the system information.

According to the rendering device and the rendering method according to the present invention, the number of the generated control points for the creation of the free curved surface or the free curved line is controlled based on the system information so that the free curved surface/free curved line is created in the operation quantity corresponding to the system statuses. Thereby, the free curved surface/free curved line can be created with the optimum rendering quality within the given rendering renewal cycle.

Further, a rendering device according to the present invention including a certain screen renewal cycle, adopts a constitution comprising:

a rendering object information acquiring unit for acquiring rendering object information;

a control point generating section for generating a control point for creating a free curved surface/free curved line based on the rendering object information generated and acknowledged by the rendering object information acquiring unit; and

a curved surface creating section for creating a curved surface based on the control point generated by the control point generating section, wherein

a rendering precision of a rendering object is changed per certain screen renewal cycle (one frame through a few frames).

The rendering device constitutes a system including the rendering unit and the rendering object information acquiring unit and adapted to render a three-dimensional object or a two-dimensional object. Further, the rendering unit is a block including the control point generating section and the curved surface creating section and adapted to execute the rendering process.

The rendering object information acquiring unit is a block which is adapted to generate at least one of moving speed information of the rendering object, display area information of the rendering object, distance information between the rendering object and a specific rendering object (herein after, referred to as object of attention), numeral information of the rendering object, size information of the rendering object, displayed period information of the rendering object and image quality information of the display unit. The control point generating section is a block adapted to generate the control point used for determining a shape of the free curved surface/free curved line when they are created. The curved surface creating section is a block adapted to create the free curved surface or the free curved line using the control point generated by the control point generating section.

According to the present invention, the control point generating section changes the number of the control points in accordance with at least one of the moving speed information of the rendering object, display area information of the rendering object, distance information between the rendering object and the object of attention, numeral information of the rendering object, size information of the rendering object, displayed period information of the rendering object and image quality information of the display unit, which are acquired and generated by the rendering object information acquiring unit so that the operation quantity required for the creation of the free curved surface/free curved line which is created by the curved surface creating section and the precision of rendering the free curved surface/free curved line is changed per screen renewal cycle.

According to the rendering device and rendering method according to the present invention, the number of the generated control points for the creation of the free curved surface/free curved line is controlled based on the rendering object information and the free curved surface/free curved line is thereby created depending on the operation quantity corresponding to the statuses of the rendering object. Thereby, the free curved surface/free curved line can be created with the optimum rendering quality within the given rendering renewal cycle.

As is clear from the foregoing description, the respective constituent elements can be constituted using hardware or software.

Additional objects and advantages of the present invention will be apparent from the following detail description of preferred embodiments thereof, which are best understood with reference to the accompanying drawings.

### BRIEF DESCRIPTION OF THE DRAWINGS

FIG. 1 is a block diagram illustrating an example of a constitution of a rendering device according to an embodiment 1 of the present invention.

FIG. 2 are illustrations of examples in which the numbers of control points generated in compliance with system information and rendering object information and created images are different in the rendering device according to the embodiment 1 and a rendering device according to an embodiment 2 of the present invention.

FIG. 3 is a flow chart for the description of changing the number of the control points in compliance with a remaining battery level in the rendering device according to the embodiment 1.

FIG. 4 is a flow chart for the description of changing the number of the control points in compliance with a clock gear ratio in the rendering device according to the embodiment 1.

FIG. 5 is a flow chart for the description of changing the number of the control points in compliance with an allocation band width in the rendering device according to the embodiment 1.

FIG. 6 is a flow chart for the description of changing the number of the control points in compliance with a bus traffic quantity in the rendering device according to the embodiment 1.

FIG. 7 is a flow chart for the description of changing the number of the control points in compliance with a network traffic quantity in the rendering device according to the embodiment 1.

FIG. 8 is a flow chart for the description of changing the number of the control points in compliance with an interruption frequency in the rendering device according to the embodiment 1.

FIG. 9 is a flow chart for the description of changing the number of the control points in compliance with a plurality of system informations in the rendering device according to the embodiment 1.

FIG. 10 is a block diagram illustrating an example of a constitution of the rendering device according to the embodiment 2.

FIG. 11 is a flow chart for the description of changing the number of the control points in compliance with a moving speed of a rendering object according to the embodiment 2.

FIG. 12 is a flow chart for the description of changing the number of the control points in compliance with an area where the rendering object is rendered according to the embodiment 2 is rendered.

FIG. 13 is a flow chart for the description of changing the number of the control points in compliance with a distance from the rendering object to an object of attention according to the embodiment 2.

FIG. 14 is a flow chart for the description of changing the number of the control points in compliance with number of the rendering objects according to the embodiment 2.

FIG. 15 is a flow chart for the description of changing the number of the control points in compliance with a size of the rendering object according to the embodiment 2.

FIG. 16 is a flow chart for the description of changing the number of the control points in compliance with a displayed period of the rendering object according to the embodiment 2.

FIG. 17 is a flow chart for the description of changing the number of the control points in compliance with an image quality of a display unit according to the embodiment 2.

FIG. 18 is a flow chart for the description of changing the number of the control points in compliance with a plurality of rendering object informations according to the embodiment 2.

FIG. 19 is an illustration of a method for determining a representative point of the rendering object according to the embodiment 2.

FIG. 20 are illustrations of a method for determining the representative point of the rendering object according to the embodiment 2.

FIG. 21 is an illustration of a method for detecting a distance between the rendering objects according to the embodiment 2.

FIG. 22 is an illustration of a method for detecting a distance between the rendering objects according to the embodiment 2.

FIG. 23 is an illustration of a method for determining a curved surface interpolating level in compliance with the display area of the rendering object according to the embodiment 2.

FIG. 24 is an illustration of a method for determining the curved surface interpolating level in compliance with the display area of the rendering object according to the embodiment 2.

FIG. 25 is an illustration of a method for determining a size of the rendering object according to the embodiment 2.

In all these figures, like components are indicated by the same numerals

### DETAILED DESCRIPTION OF THE PREFERRED EMBODIMENTS

A rendering device according to the present invention comprises:

an information acquiring unit for acquiring system information or rendering object information;

a control point generating section for setting a curved surface interpolating level serving to determine the number of control points for creating a curved surface or a curved line based on the acquired information and thereby generating the control point in accordance with the curved surface interpolating level; and

a curved surface creating section for creating the curved surface based on the control point, and is adapted to dynamically change an operation quantity for rendering the curved surface of a display object based on the acquired information. The control point generating section and the curved surface creating section constitute a rendering unit, which is a block for performing a rendering process.

The system information is at least one of a remaining battery level of a power supply, a clock gear ratio of the rendering device, an allocated band width of the rendering device with respect to a memory unit, a bus traffic quantity of an interconnection network, a network traffic quantity of a network, an interruption frequency with respect to the rendering device and the like. The rendering object information is at least one of moving-speed information of a created rendering object, display area information of the rendering object, distance information between the rendering object and an object of attention, numeral information of the rendering object, size information of the rendering object, displayed period information of the rendering object, image quality information of the display unit and the like.

According to the rendering device constituted in the foregoing manner, the free curved surface/free curved line can be created with an optimum rendering quality in accordance with statuses of the rendering object and system. The optimum rendering quality denotes a rendering quality of a highest precision that can be achieved by the rendering process completed within the screen renewal cycle or a rendering quality that can comply with views of a producer or a user of the rendering device.

A rendering device according to the present invention comprises:

a system information acquiring unit for acquiring system information;

a control point generating section for setting a curved surface interpolating level serving to determine the number of control points for creating a curved surface or a curved line based on the system information and thereby generating the control point in accordance with the curved surface interpolating level; and a curved surface creating section for creating the curved surface based on the control point, and is adapted to dynamically change an operation quantity for rendering the curved surface of a display object based on the system information. The control point generating section and the curved surface creating section constitute a rendering unit, which is a block for performing a rendering process. The control point generating section changes the number of the control points used for the creation of the free curved surface free curved line in accordance with the acquired system information and thereby changes the operation quantity required for the creation of the free curved surface/free curved line which are created by the curved surface creating section.

In a rendering method according to the present invention corresponding to the foregoing rendering device, the system information is acquired, the curved surface interpolating level for creating the curved surface or the curved line is determined based on the system information so that the control point is generated, the curved surface is created based on the control point, and the operation quantity for rendering the curved surface rendering of the display object is thereby dynamically changed based on the system information.

According to the rendering device constituted in the foregoing manner, the free curved surface/free curved line can be created with the optimum rendering quality in accordance with the statuses of the system.

The foregoing constitution includes a plurality of modes for constituent elements of the system information acquiring unit, which are sequentially described below.

1) The system information shows the remaining battery level (a remaining quantity of electric power which can be supplied by a power supply device of some sort to the rendering device when the rendering device is supplied with the electric power from the power supply device), and a remaining battery level information acquiring section for acquiring the remaining battery level is comprised.

When the remaining battery level fails to satisfy given conditions, the number of the generated control points is reduced to such an extent that the rendering precision is discernibly degraded so that the user can judge the remaining battery level from the current rendering precision of the display object.

2) The system information shows the clock gear ratio (a ratio of a clock cycle of the rendering unit relative to a specific block or a ratio of the clock cycle of the rendering unit relative to a reference clock cycle when a mechanism capable of changing the clock frequencies of the respective blocks in the rendering device is included), and a clock gear ratio information acquiring section for acquiring the clock gear ratio is comprised.

The clock gear ratio, which represents an operation performance, is thus reflected on the operation quantity required for the creation of the free curved surface/free curved line. In the foregoing manner, the free curved surface/free curved line can be created with the optimum rendering quality in accordance with the clock gear ratio because the number of the control points for the creation of the free curved surface/free curved line is changed in accordance with the clock gear ratio representing a system status and the free curved surface/free curved line can be created based on the control points whose number is thus adjusted. More specifically, the larger the clock gear ratio is, the more number of control points are generated so that the free curved surface/free curved line can be created with a higher precision. On the contrary, the number of the control points is reduced as the clock gear ratio is smaller so that the operation quantity can be reduced and the power consumption can be accordingly reduced.

3) The system information is the allocation band width information of the rendering device with respect to the memory unit (a capacity of data transfer per unit time by which the rendering unit is allowed to make an access with respect to the memory unit in the case in which the rendering device is adapted to comprise a memory unit including a main memory, a frame buffer and the like), and an allocation band width information acquiring section for acquiring the allocation band width information is comprised.

The allocation band width, which represents an operation performance, is thus reflected on the operation quantity required for the creation of the free curved surface/free curved line. In the foregoing manner, the free curved surface/free curved line can be created with the optimum rendering quality in accordance with the allocation band width because the number of the control points for the creation of the free curved surface/free curved line is changed in accordance with the allocation band width and the free curved surface/free curved line can be created based on the control points whose number is thus adjusted. More specifically, the larger the allocation band width is, the more number of control points are generated so that the free curved surface/free curved line can be created with a higher precision. On the contrary, the number of the control points is reduced as the allocation band width is smaller so that the operation quantity can be reduced and the power consumption can be accordingly reduced.

4) The system information shows the bus traffic quantity of the interconnection network (a data traffic quantity on the interconnection network such as a bus which connects the rendering unit, memory unit, display unit and the like), and a bus traffic information acquiring section for acquiring the bus traffic quantity is comprised.

The bus traffic quantity, which represents a system status, is thus reflected on the operation quantity for the creation of the free curved surface/free curved line. In the foregoing manner, the free curved surface/free curved line can be created in an optimum rendering quality in accordance with the bus traffic quantity because the number of the control points for the creation of the free curved surface/free curved line is changed in accordance with the bus traffic quantity and the free curved surface/free curved line can be created based on the control points whose number is thus adjusted. More specifically, the smaller the bus traffic quantity is, the more number of control points are generated so that the free curved surface/free curved line can be created with a higher precision. On the contrary, the number of the control points is reduced as the bus traffic quantity is increased so that the operation-quantity can be reduced and the power consumption can be accordingly reduced.

5) The system information shows the network traffic quantity (a data traffic quantity on a network connecting the rendering device and outside), and a network traffic information acquiring section for acquiring the network traffic quantity is comprised.

The network traffic quantity, which represents a system status, is thus reflected on the operation quantity for the creation of the free curved surface/free curved line. In the foregoing manner, the free curved surface/free curved line can be created with the optimum rendering quality in accordance with the network traffic quantity because the number of the control points for the creation of the free curved surface/free curved line is changed in accordance with the network traffic quantity and the free curved surface/free curved line can be created based on the control points whose number is thus adjusted. More specifically, the smaller the network traffic quantity is, the more number of control points are generated so that the free curved surface/free curved line can be created with a higher precision. On the contrary, the number of the control points is reduced as the network traffic quantity is increased so that the operation quantity can be reduced and the power consumption can be accordingly reduced.

6) The system information shows the interruption frequency (a frequency of the issuance of an interruption instruction with respect to the rendering device or the rendering unit or a relevant interruption process resulting from an external factor such as the user's manipulation or an internal factor such as a privileged instruction), and an interruption frequency information acquiring section for acquiring the interruption frequency is comprised.

The interruption frequency, which represents a system status, is thus reflected on the operation quantity for the creation of the free curved surface/free curved line. In the foregoing manner, the free curved surface/free curved line can be created with the optimum rendering quality in accordance with the interruption frequency because the number of the control points for the creation of the free curved surface/free curved line is changed in accordance with the interruption frequency and the free curved surface/free curved line can be created based on the control points whose number is thus adjusted. More specifically, the smaller the interruption frequency is, the more number of the control points are generated so that the free curved surface/free curved line can be created with a higher precision. On the contrary, the number of the control points is reduced as the interruption frequency is increased so that the operation quantity can be reduced and the power consumption can be accordingly reduced.

7) The system information shows at least two of the remaining battery level, clock gear ratio, allocation band width, bus traffic quantity, network traffic quantity and interruption frequency with respect to the rendering device. Correspondingly, at least two of the remaining battery level information acquiring section, clock gear ratio information acquiring section, allocation band width information acquiring section, bus traffic information acquiring section, network traffic information acquiring section and interruption frequency information acquiring section are comprised.

Referring to the setting of the operation quantity in the rendering device constituted as described, the operation quantity may be simply set depending on if the system information is higher or lower than a previously set value or may be changed a phased manner in accordance with the system information.

Referring to the calculation of the operation quantity in the rendering device constituted as described, the operation quantity may be obtained from the curved surface interpolating level, the number of the control points, or both of the curved surface interpolating level and the number of the control points.

The screen renewal cycle is the number of cycles when image data is transmitted to the display unit, and the rendering device having the certain screen renewal cycle represents a rendering device in which the screen is renewed 30 times per second in the case of 30 fps. When the screen renewal cycle is set to be shorter, it appears that the rendering object can be smoothly moved and reshaped, while it becomes necessary to complete address generation, rendering process of the rendering object and write process with respect to the frame buffer, which are required for a mapping process with respect to a virtual three-dimensional space (or virtual two-dimensional space), within the screen renewal cycle.

For example, in the case of 30 fps, the write process with respect to the frame buffer is executed per 1/30 second, however, the operation quantity for the free curved surface/free curved line created by the curved surface creating section and the precision of rendering the free curved surface/free curved line may be changed, not only for one frame ( 1/30 second) but also for a few frames ( 1/30×n seconds).

The rendering object is an object to be rendered by the rendering device in the virtual three-dimensional space (or virtual two-dimensional space) within the screen renewal cycle, and a part or entirety of the rendering object constitute the free curved surface/free curved line.

The rendering object information is at least one of the moving speed information of the created rendering object, display area information of the rendering object, distance information between the rendering object and the object of attention, numeral information of the rendering object, size information of the rendering object, displayed period information of the rendering object and image quality information of the display unit.

The moving speed of the rendering object is a speed at which the rendering object moves within the certain rendering renewal cycle. It is assumed here that a moving distance used for calculating the moving speed is a distance in which a representative point of the rendering object moves within the certain screen renewal cycle. The representative point may be obtained from an operation based on a plurality of control points (center of gravity or the like) or may be previously selected from the control points. The distance may be a linear distance in the virtual three-dimensional space (or virtual two-dimensional space) or may be a distance calculated by means of a predetermined calculation method. The certain rendering renewal cycle may correspond to one frame or a few frames. Therefore, the operation quantity for the creation of the free curved surface/free curved line can be changed based on the moving distance of the rendering object within the certain screen renewal cycle, that is the moving speed, and the precision of rendering the free curved surface/free curved line can be accordingly changed. Further, when an reduced number of control points are generated in the rendering object whose moving speed is fast in comparison to the rendering object whose moving speed is slow, the operation quantity for the creation of the rendering object moving at such a speed that a correct shape of the object is hardly recognizable to the user can be controlled.

To describe the display area information of the rendering object, a two-dimensional space resulting from excluding a depth direction from the virtual three-dimensional space (or virtual two-dimensional space), which can be viewed in the display unit, is divided into a plurality of display areas designated prior to or during the actuation of the rendering device, and in which display area each rendering object is displayed is indicated by the display area information serving as a positional information. It is thereby judged which display area the rendering object is disposed, and the control point used for rendering the free curved surface/free curved line is generated with a precision previously defined in the area to which the rendering object belongs. In the present case, which area the rendering object belongs to is judged by coordinates of the representative point of the rendering object. Further, in the present case, the representative point may be obtained by means of the operation based on the plurality of control points (center of gravity or the like) or may be previously selected from the control points. The representative point is not necessarily a single point, and the plurality of control points or all of the control points may be used as the representative points. In the case of a plurality of representative points, the rendering object may be displayed in a display area to which a largest number of representative points belong, or the respective representative points may alternatively respectively have different display areas.

Therefore, according to the present invention, the operation quantity for the creation of the free curved surface/free curved line can be changed in response to the display area to which the rendering object belongs, which enables the precision of rendering the free curved surface/free curved line to be changed. Further when it is adapted that a rendering object distant from the center of the display unit is provided with the generated control points fewer than in a rendering object closer thereto, the operation quantity for the creation of any rendering object whose correct shape is hardly recognizable to the user when he/she closely watches a central part of the display unit can be controlled.

The distance of the rendering object relative to the object of attention is a distance present between the rendering object and the object of attention. The object of attention is a rendering object designated in the virtual three-dimensional space (or virtual two-dimensional space) by the user via a program or data previously incorporated or incorporated during the actuation in the memory unit, a program or data set via a network or a manipulation unit. The distance may be a linear distance in the virtual three-dimensional space (or virtual two-dimensional space) or may be the distance calculated by means of the predetermined calculation method. Therefore, according to the present invention, the operation quantity for the creation of the free curved surface/free curved line and the precision of rendering the free curved surface/free curved line can be changed based on the distance of the rendering object relative to the object of attention. Further, when a rendering object distant from the object of attention is provided with the generated control points fewer than in a rendering object closer thereto, the operation quantity for the creation of any rendering object whose correct shape is hardly recognizable to the user can be controlled.

The number of the rendering objects is the number of objects rendered in the virtual three-dimensional space (or virtual two-dimensional space). Therefore, according to the present invention, the operation quantity for the creation of the free curved surface/free curved line and the precision of rendering the free curved surface/free curved line can be changed based on the number of the rendering objects.

Alternatively, the precision of rendering the free curved surface/free curved line may be changed on the basis of, not only the number of the rendering objects, but also, for example, a total number of the control points or the number of the representative points for the creation of the relevant rendering object. Further, the operation quantity for the creation of any rendering object whose correct shape is hardly recognizable to the user can be controlled when the number of the generated control points is reduced in the case of a rendering object including a large number of objects to be rendered in comparison to a rendering object including a small number of rendering objects to be rendered.

The size of the rendering object is a size of the rendering object which is recognized by the user in the virtual three-dimensional space (or virtual two-dimensional space) through the display device. The size may refer to a linear distance between two representative points selected from the control points or may be determined based on a calculation result of an average value of distances from centers of gravity of a plurality of representative points to the respective control points. Therefore, according to the present invention, the operation quantity for the creation of the free curved surface free curved line and the rendering precision of the free curved surface/free curved line can be changed based on the size of the rendering objects. Further, the operation quantity for the creation of any rendering object whose correct shape is hardly recognizable to the user can be controlled when the number of the generated control points is reduced in the case of a rendering object small in size in comparison to a rendering object large in size.

The displayed period of the rendering object denotes a length of time having passed since the rendering object is shown in the virtual three-dimensional space (or virtual two-dimensional space) recognized by the user through the display unit, in other words, a length of time having passed since a rendering result is written in a frame buffer region that is transmitted to the display unit. Therefore, according to the present invention, the operation quantity for the creation of the free curved surface/free curved line can be changed based on the length of time that has elapsed since the rendering object is displayed on the display unit, and the rendering precision of the free curved surface/free curved line can be thereby changed. Further, the operation quantity for the creation of any rendering object whose correct shape is hardly recognizable to the user can be controlled when the number of the generated control points is reduced in the case of a rendering object having a shorter displayed period of the rendering object in comparison to a rendering object having a longer displayed period of the rendering object.

The image quality set in the display unit is a color gradation, brightness, contrast, definition, resolution and the like, representing performances of the display unit, which influences on how the rendering object is viewed by the user or set values thereof. The foregoing factors impart influences in terms of color sense, which decides a degree of a clear vision of the rendering object, to the user. Therefore, according to the present invention, the operation quantity for the creation of the free curved surface/free curved line can be changed in the rendering based on the image quality set in the display unit, and the rendering precision of the free curved surface/free curved line can be thereby changed object. Further, the operation quantity for the creation of any rendering object whose correct shape is hardly recognizable to the user can be controlled when the number of the generated control points is reduced when a high image quality is set in the display unit in comparison to a low image quality set in the display unit.

The rendering object information acquiring unit may be realized by means of hardware or a program. The control point generating section unit may be realized by means of hardware or a program. The curved surface creating section may be realized by means of hardware or a program.

Hereinafter, embodiments of the rendering device and the rendering method according to the present invention are described in detail referring to the drawings.

### Embodiment 1

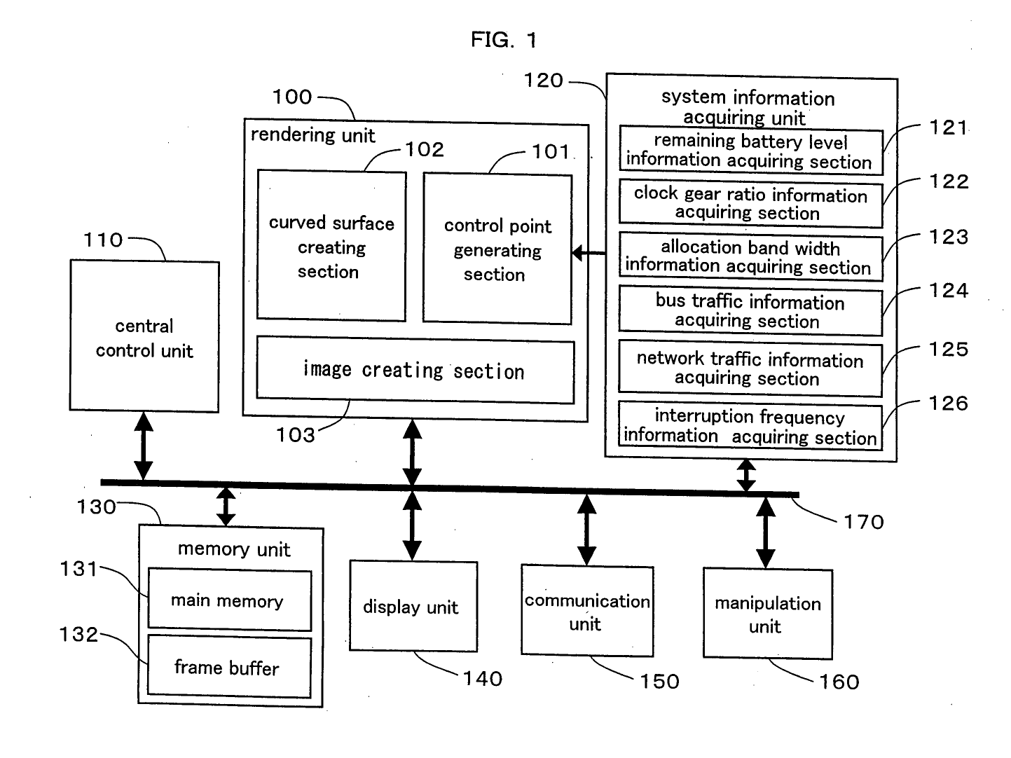

FIG. 1 shows a constitution of a rendering device according to an embodiment 1 of the present invention.

The present embodiment necessarily includes at least a rendering unit 100 and a system information acquiring unit 120, and the presence or absence and constitution of any other block are optionally determined. A central control unit 110 is in charge of the management of an entire system and executes different processes such as instructions to the respective blocks in the system. A memory unit 130 constitutes a work region for the central control unit 110, rendering unit 100 and communication unit 150, and functions as a main memory 131 and a frame buffer 132. A display unit 140 serves to output an image created according to the present embodiment. The communication unit 150 is in charge of communications between the rendering device and an external system via a network or the like.

A program or data according to the present embodiment may adopt such a manner that they are stored in the memory unit 130 or delivered to a control point generating section 101 via the network and communication unit 150. An manipulation unit 160 is used by the user to manipulate the rendering device.

The system information acquiring unit 120 comprises at least one of a remaining battery level information acquiring section 121, a clock gear ratio information acquiring section 122, an allocation band width information acquiring section 123, a bus traffic information acquiring section 124, a network traffic information acquiring section 125 and an interruption frequency information acquiring section 126.

The remaining battery level information acquiring section 121 acknowledges a remaining battery level of a power supply device comprising a battery which supplies the rendering unit 100 with electric power and the like. The clock gear ratio information acquiring section 122 acknowledges a clock gear ratio of the rendering unit 100 relative to a given block or a clock gear ratio of the image-rendering unit 100 relative to a given reference frequency when the rendering device comprises a clock gear function capable of changing frequencies of the respective blocks.

The allocation band width information acquiring section 123 acknowledges a capacity of data transfer per unit time from the rendering unit 100 to the memory unit 130.

The bus traffic information acquiring section 124 acknowledges a bus traffic on a bus 170 which connects the rendering unit 100, memory unit 130 and the like with one another.

The network traffic information acquiring section 125 acknowledges a transfer capacity per unit time of the network through which data is transmitted and received via the communication unit 150.

The interruption frequency information acquiring section 126 acknowledges a quantity of interruptions per unit time made by the central control unit 110, communication unit 150, manipulation unit 160 or the like with respect to the rendering unit 100.

The rendering unit 100 renders an image including the rendering of a free curved surface and a free curved line and the like based on the central control section 110 or program. The rendering unit 100 includes the control point generating section 101, curved surface creating section 102 and image creating section 103.

The control point generating section 101 executes a process of changing the number of control points used for the creation of the free curved surface or the free curved line in compliance with at least one of the remaining battery level information, clock gear ratio information, allocation band width information, bus traffic information, network traffic information and interruption frequency information acquired by the system information acquiring unit 120 or a combination thereof.

The control point is used for determining a shape of the free curved line when the free curved surface/free curved line is created by means of a parametric curve such as Bezier curve and spline curve. When the spline curve or an extended form thereof is used as a tool for creating the free curved surface/free curved line, an entire curved line is obtained when the control points are smoothly connected (interpolated) based on coordinates of the control points. When the Bezier curve or NURBS (Non Uniform Rational B-Spline) is used as a tool for creating the free curved surface/free curved line, first and last control points of the given control points are connected though the control points there between are only used for determining a curve shape of the curved line.

The number of the control points may be determined by means of hardware in the control point generating section 101, may be determined by means of the program in the memory unit 130, or may be determined by means of the data or program transmitted through the network via the communication unit 150.

The free surface creating section 102 creates the free curved surface/free curved line using the control points generated by the control point generating section 101.

The curved surface and the curved line may be created by means of the hardware, may be created by means of the program in the memory unit 130, or may be formed by means of the data transmitted through the network via the communication unit 150.

The image creating section 103 creates a shape of a display object using the free curved surface or the free curved line created by the curved surface creating section 102 and executes different types of image creation processes to the display object, such as geometry operation, light source process, shading process, texture generation, filtering process, α-blending process, fog process and the like, and further, a process for storing the display object at a relevant address in the frame buffer 132 of the memory unit 130.

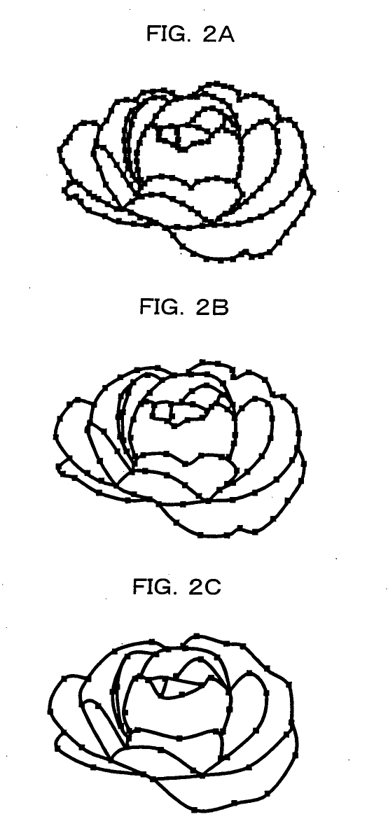

FIGS. 2A, 2B and 2C illustrate examples of changing the control points for the creation of the free curved line in accordance with the system information. FIG. 2A shows an image in which it is judged from the acquired system information a highly precise free curved line can be sufficiently rendered. FIG. 2B shows an image in which it is judged to be difficult to render a highly precise free curved based on the acquired system information and the free curved line is created with an intermediate precision. FIG. 2C shows an image in which it is judged to be difficult to render the free curved line of the intermediate precision and the free curved line is created with a low precision.

The rendering is carried out based on judgments on the possibility of completing the rendering within a rendering renewal cycle, remaining electric power level and the like.

In the present embodiment, when system statuses, such as a status of a currently used system resource, satisfy given conditions, the free curved surface is highly precisely rendered even when an image of the same display object is created. When the system information fails to satisfy the conditions for rendering the highly precise free curved surface/free curved line, the precision of the free curved surface/free curved line can be changed from the high precision to the intermediate precision or low precision so that the operation quantity can be changed.

In FIG. 2, three stages of “high” (FIG. 2A), “intermediate” (FIG. 2B) and “low” (FIG. 2C) are prepared as curved surface interpolating levels, and the number of the control points of FIG. 2B is arbitrarily reduced to a half of that of FIG. 2A and the number of the control points of FIG. 2C is arbitrarily reduced to a half of that of FIG. 2B. However, in the present invention, the number of the curved surface interpolating levels, number of the control points and method for selecting the control points to be generated are not limited to the foregoing description, and may be realized by means of the program that can be stored in and implemented by the memory unit 130 or may be determined based on an external data or the like via the network, or a given method for determining them can be developed into hardware. Further, the system information is compared to the conditions whenever the image is created in the foregoing description. However, in the present invention, the curved surface interpolating level in compliance with the system information is not necessarily determined based on the foregoing timing. The number of the control points can be changed, for example, in response to the system information only at a predetermined cycle.

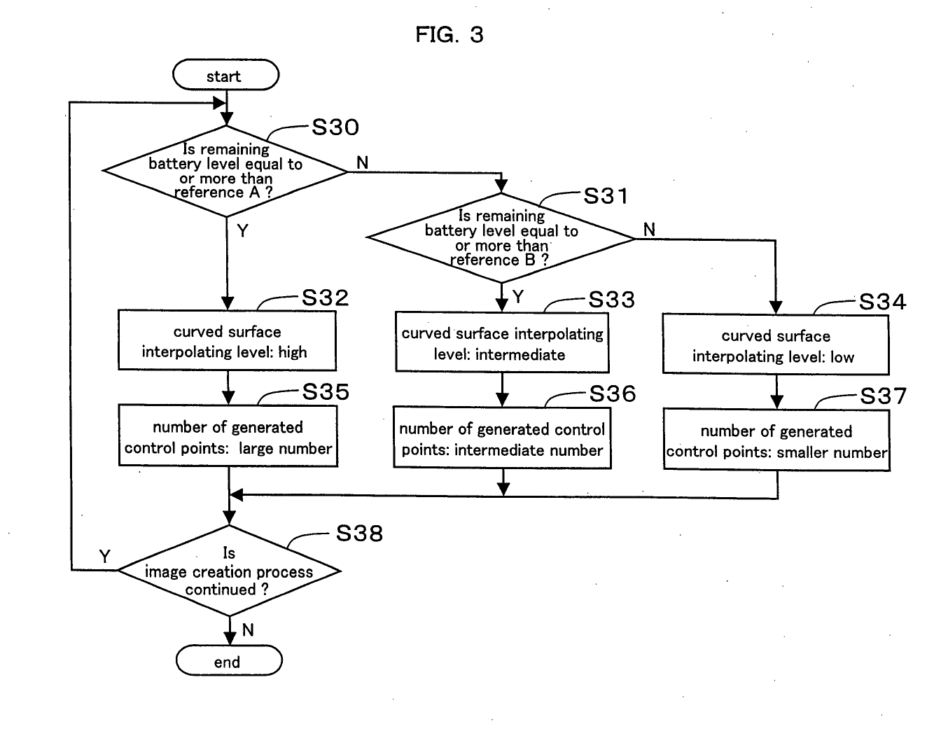

Referring to FIG. 3, which is an example of a process flow according to the present embodiment, a flow of a process, in which the rendering precision of the free curved line is changed by controlling the number of the generated control points depending on the remaining battery level, is described.

When the remaining battery level acquired by the system information acquiring unit 120 is equal to or exceeds a reference A, the curved surface interpolating level is set to “high” so that a large number of control points are generated. In such a manner, a highly precise free curved line can be created while the operation quantity is increased (Step S30, S32 and S35).

When the remaining battery level acquired by the system information acquiring unit 120 is equal to or exceeds a reference B and below the reference A, the curved surface interpolating level is set to “intermediate” so that an intermediate number of control points are generated. In such a manner, an intermediate-precision free curved line can be created while the operation quantity is reduced in comparison to the operation quantity in the case of the high-precision curved line (Step S30, S31, S33 and S36).

When the remaining battery level is less than the reference B, the curved surface interpolating level is set to “low” so that a smaller number of control points are generated. Thus, a low-precision free curved line can be created while the operation quantity is further reduced (Step S30, S31, S34 and S37).

Then, whether or not the image is continuously created within a next image renewal cycle is decided (Step S38). When it is decided that the image creation continues, the Steps S30-S37 are repeated.

In FIG. 3, the three stages of the high precision, intermediate precision and low precision are given as the curved surface interpolating levels, however, the curved surface interpolating levels according to the present invention are not necessarily limited to those three stages. When a more minute range of reference levels are provided for the remaining battery level and the curved surface interpolating levels respectively corresponding to the range are decided, the remaining battery level can be more flexibly reflected on the operation quantity for the creation of the free curved surface/free curved line. When the remaining battery level fails to satisfy the given conditions, the number of the generated control points is reduced to such an extent that the rendering precision is discernibly degraded so that the user can judge the remaining battery level from the current rendering precision of the display object. The decision of the curved surface interpolating level and number of the control points may be realized by means of the program that can be stored in and implemented by the memory unit 130 or may be realized based on the external data or the like via the network, or a given method for realizing them can be developed into hardware. Even when the decision of the curved surface interpolating level is developed into the hardware and cannot be changed, the number of the control points can be changed in a different manner by using the program that can be stored in and implemented by the memory unit 130 and the external data or the like via the network as a method for deciding the number of the control points based on the decided curved surface interpolating level.

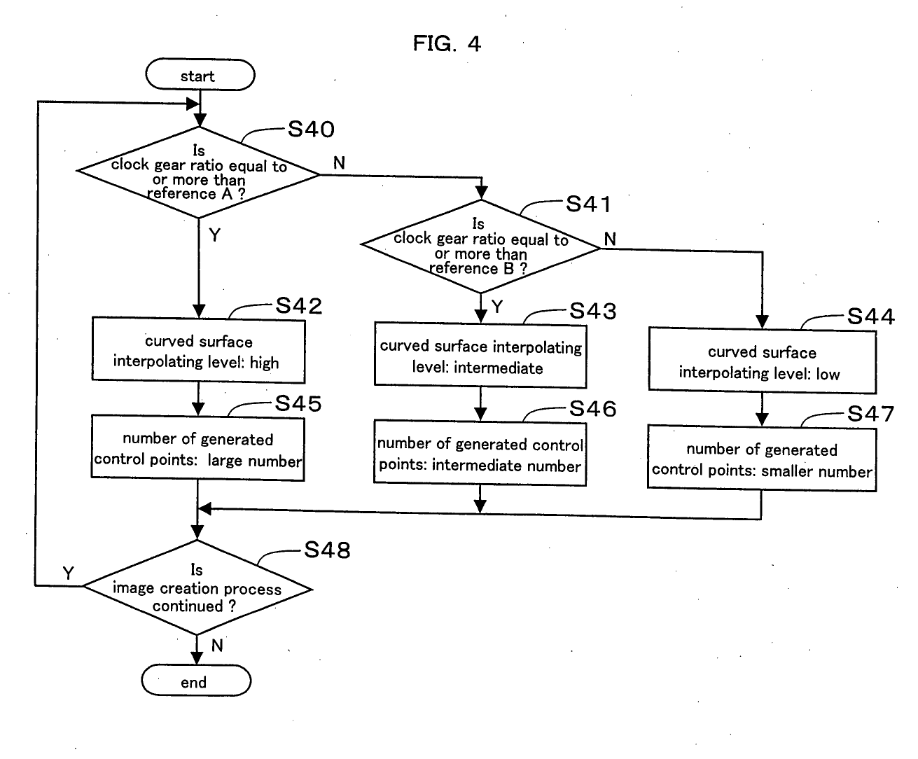

Referring to FIG. 4, which is an example of a process flow according to the present embodiment, a flow of a process, in which the rendering precision of the free curved line is changed by controlling the number of the generated control points depending on the clock gear ratio, is described.

When the clock gear ratio acquired by the system information acquiring unit 120 is equal to or exceeds a reference A, the curved surface interpolating level is set to “high” so that a large number of control points are generated. In such a manner, a highly precise free curved line can be created while the operation quantity is increased (Step S40, S42 and S45).

When the clock gear ratio is equal to or exceeds a reference B and below the reference A, the curved surface interpolating level is set to “intermediate” so that an intermediate number of control points are generated. In such a manner, an intermediate-precision free curved line can be created while the operation quantity is reduced in comparison to the operation quantity in the case of the high-precision curved line (Step S40, S41, S43 and S46).

When the clock gear ratio is less than the reference B, the curved surface interpolating level is set to “low” so that a smaller number of control points are generated. Thus, a low-precision free curved line can be created while the operation quantity is further reduced (Step S40, S41, S44 and S47).

Then, whether or not the image is continuously created within the next image renewal cycle is decided (Step S48). When it is decided that the image creation continues, the Steps S40-S47 are repeated.

In FIG. 4, the three stages of the high precision, intermediate precision and low precision are given as the curved surface interpolating level, however, the curved surface interpolating levels according to the present invention are not necessarily limited to those three stages. When a more minute range of references are provided for the clock gear ratio and the curved surface interpolating levels respectively corresponding to the range are decided, the clock gear ratio can be more flexibly reflected on the operation quantity for the creation of the free curved surface/free curved line. The decision of the curved surface interpolating level and number of the control points may be realized by means of the program that can be stored in and implemented by the memory unit 130 or may be realized based on the external data or the like via the network, or a given method for realizing them can be developed into hardware. Even when the decision of the curved surface interpolating level is developed into the hardware and cannot be changed, the number of the control points can be changed in a different manner by using the program that can be stored in and implemented by the memory unit 130 and the external data or the like via the network as a method for deciding the number of the control points based on the decided curved surface interpolating level.

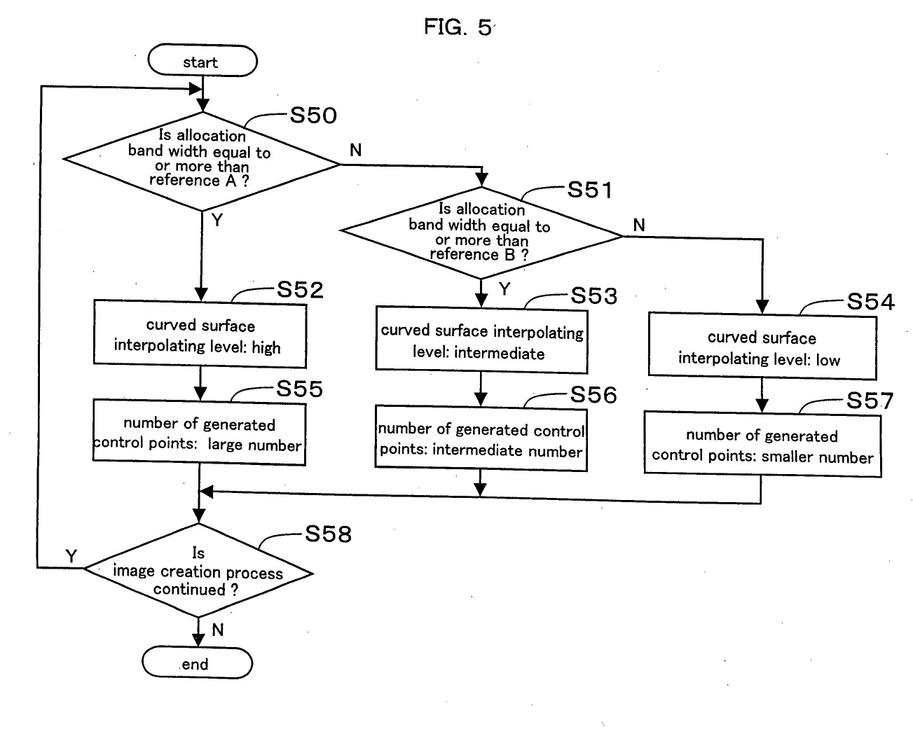

Referring to FIG. 5, which is an example of a process flow according to the present embodiment, a flow of a process, in which the rendering precision of the free curved line is changed by controlling the number of the generated control points depending on the allocation band width, is described.

When the allocation band width acquired by the system information acquiring unit 120 is equal to or exceeds a reference A, the curved surface interpolating level is set to “high” so that a large number of control points are generated. In such a manner, a highly precise free curved line can be created while the operation quantity is increased (Step S50, S52 and S55).

When the allocation band width is equal to or exceeds a reference B and below the reference A, the curved surface interpolating level is set to “intermediate” so that an intermediate number of control points are generated. In such a manner, an intermediate-precision free curved line can be created while the operation quantity is reduced in comparison to the operation quantity in the case of the high-precision curved line (Step S50, S51, S53 and S56).

When the allocation band width is less than the reference B, the curved surface interpolating level is set to “low” so that a smaller number of control points are generated. Thus, a low-precision free curved line can be created while the operation quantity is further reduced (Step S50, S51, S54 and S57).

Then, whether or not the image is continuously created within the next image renewal cycle is decided (Step S58). When it is decided that the image creation continues, the Steps S50-S57 are repeated.

In FIG. 5, the three stages of the high precision, intermediate precision and low precision are given as the curved surface interpolating level, however, the curved surface interpolating levels according to the present invention are not necessarily limited to those three stages. When a more minute range of references are provided for the allocation band width and the curved surface interpolating levels respectively corresponding to the range are decided, the allocation band width can be more flexibly reflected on the operation quantity for the creation of the free curved surface/free curved line. The decision of the curved surface interpolating level and number of the control points may be realized by means of the program that can be stored in and implemented by the memory unit 130 or may be realized based on the external data or the like via the network, or a given method for realizing them can be developed into hardware. Even when the decision of the curved surface interpolating level is developed into hardware and cannot be changed, the number of the control points can be changed in a different manner by using the program that can be stored in and implemented by the memory unit 130 and the external data or the like via the network as a method for deciding the number of the control points based on the decided curved surface interpolating level.

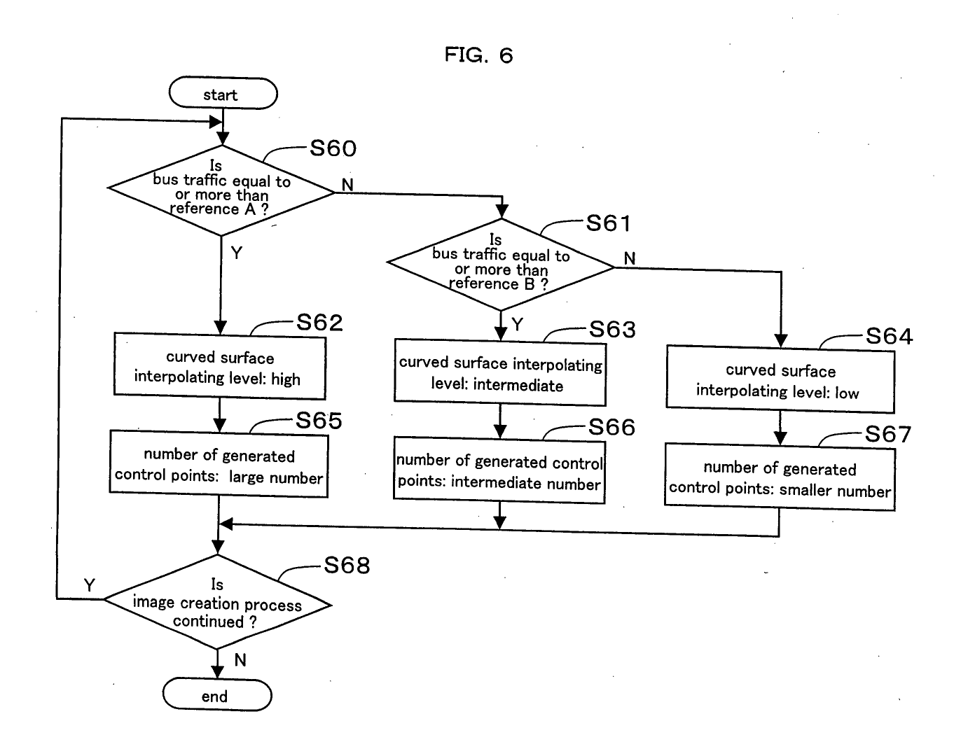

Referring to FIG. 6, which is an example of a process flow according to the present embodiment, a flow of a process, in which the rendering precision of the free curved line is changed by controlling the number of the generated control points depending on the bus traffic, is described.

When the bus traffic acquired by the system information acquiring unit 120 is equal to or below a reference A, the curved surface interpolating level is set to “high” so that a large number of control points are generated. In such a manner, a highly precise free curved line can be created while the operation quantity is increased (Step S60, S62 and S65).

When the bus traffic exceeds the reference A and is equal to or below a reference B, the curved surface interpolating level is set to “intermediate” so that an intermediate number of control points are generated. In such a manner, an intermediate-precision free curved line can be created while the operation quantity is reduced in comparison to the operation quantity in the case of the high-precision curved line (Step S60, S61, S63 and S66).

When the bus traffic exceeds the reference B, the curved surface interpolating level is set to “low” so that a smaller number of control points are generated. Thus, a low-precision free curved line can be created while the operation quantity is further reduced (Step S60, S61, S64 and S67).

Then, whether or not the image is continuously created within the next image renewal cycle is decided (Step S68). When it is decided that the image creation continues, the Steps S60-S67 are repeated.

In FIG. 6, the three stages of the high precision, intermediate precision and low precision are given as the curved surface interpolating level, however, the curved surface interpolating levels according to the present invention are not necessarily limited to those three stages. When a more minute range of reference's are provided for the bus traffic and the curved surface interpolating levels respectively corresponding to the range are decided, the bus traffic can be more flexibly reflected on the operation quantity for the creation of the free curved surface/free curved line. The decision of the curved surface interpolating level and number of the control points may be realized by means of the program that can be stored in and implemented by the memory unit 130 or may be realized based on an external data or the like via the network or a given method for realizing them can be developed into hardware. Even when the decision of the curved surface interpolating level is developed into the hardware and cannot be changed, the number of the control points can be changed in a different manner by using the program that can be stored in and implemented by the memory unit 130 and the external data or the like via the network as a method for deciding the number of the control points based on the decided curved surface interpolating level.

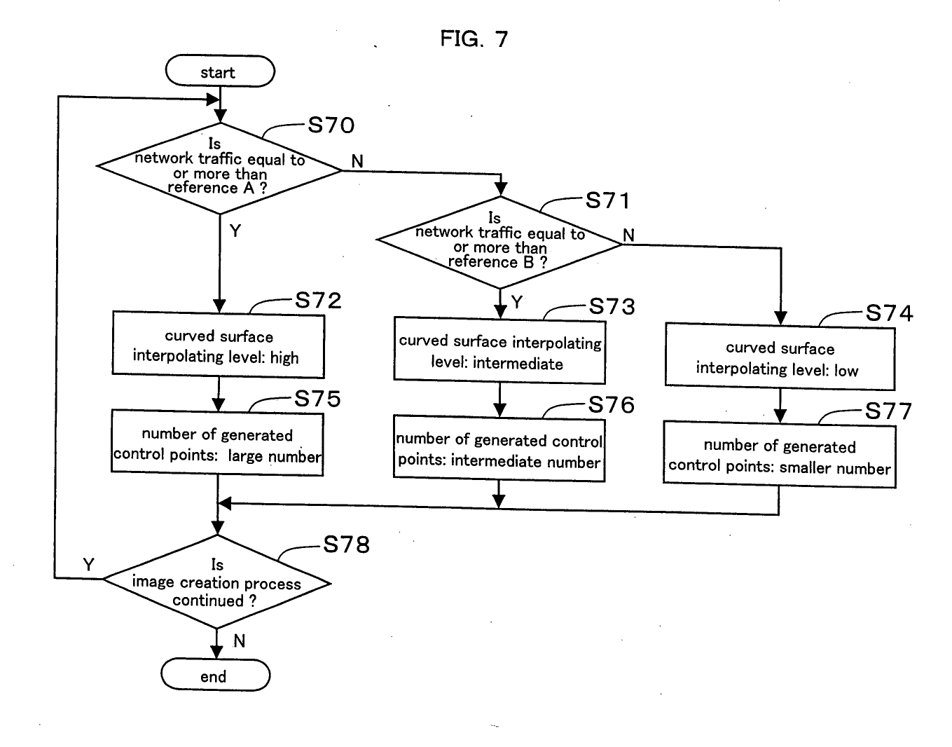

Referring to FIG. 7, which is an example of a process flow according to the present embodiment, a flow of a process, in which the rendering precision of the free curved line is changed by controlling the number of the generated control points depending on the network traffic, is described.

When the network traffic is equal to or below a reference A, the curved surface interpolating level is set to “high” so that a large number of control points are generated. In such a manner, a highly precise free curved line can be created while the operation quantity is increased (Step S70, S72 and S75).

When the network traffic exceeds the reference A and is equal to or below a reference B, the curved surface interpolating level is set to “intermediate” so that an intermediate number of control points are generated. In such a manner, an intermediate-precision free curved line can be created while the operation quantity is reduced in comparison to the operation quantity in the case of the high-precision curved line (Step S70, S71, S73 and S76).

When the network traffic exceeds the reference B, the curved surface interpolating level is set to “low” so that a smaller number of control points are generated. Thus, a low-precision free curved line can be created while the operation quantity is further reduced (Step S70, S71, S74 and S77).

Then, whether or not the image is continuously created within the next image renewal cycle is decided (Step S78). When it is decided that the image creation continues, the Steps S70-S77 are repeated.

In FIG. 7, the three stages of the high precision, intermediate precision and low precision are given as the curved surface interpolating level, however, the curved surface interpolating levels according to the present invention are not necessarily limited to those three stages. When a more minute range of references are provided for the network traffic and the curved surface interpolating levels respectively corresponding to the range are decided, the network traffic can be more flexibly reflected on the operation quantity for the creation of the free curved surface/free curved line. The decision of the curved surface interpolating level and number of the control points may be realized by means of the program that can be stored in and implemented by the memory unit 130 or may be realized based on the external data or the like via the network, or a given method for realizing them can be developed into hardware. Even when the decision of the curved surface interpolating level is developed into the hardware and cannot be changed, the number of the control points can be changed in a different manner by using the program that can be stored in and implemented by the memory unit 130 and the external data or the like via the network as a method for deciding the number of the control points based on the decided curved surface interpolating level.

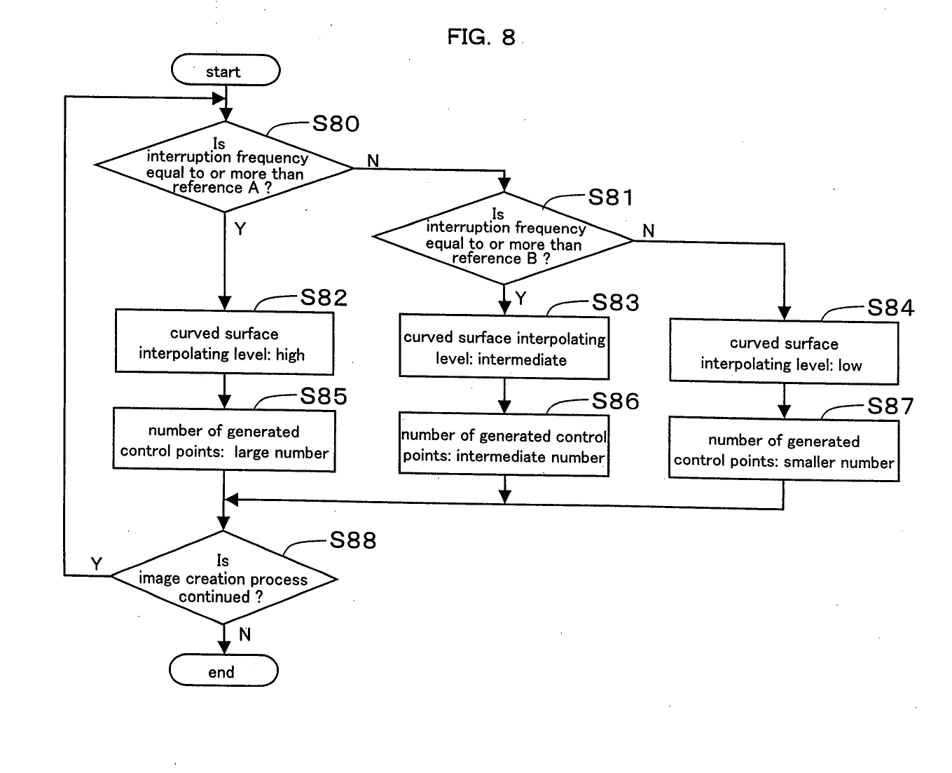

Referring to FIG. 8, which is an example of a process flow according to the present embodiment, a flow of a process, in which the rendering precision of the free curved line is changed by controlling the number of the generated control points depending on the interruption frequency, is described.

When the interruption frequency acquired by the system information acquiring unit 120 is equal to or below a reference A, the curved surface interpolating level is set to “high” so that a large number of control points are generated. In such a manner, a highly precise free curved line can be created while the operation quantity is increased (Step S80, S82 and S85).

When the interruption frequency exceeds the reference A and is equal to or below a reference B, the curved surface interpolating level is set to “intermediate” so that an intermediate number of control points are generated. In such a manner, an intermediate-precision free curved line can be created while the operation quantity is reduced in comparison to the operation quantity in the case of the high-precision curved line (Step S80, S81, S83 and S86).

When the interruption frequency exceeds the reference B, the curved surface interpolating level is set to “low” so that a smaller number of control points are generated. Thus, a low-precision free curved line can be created while the operation quantity is reduced (Step S80, S81, S84 and S87).

Then, whether or not the image is continuously created within the next image renewal cycle is decided (Step S88). When it is decided that the image creation continues, the Steps S80-S87 are repeated.

In FIG. 8, the three stages of the high precision, intermediate precision and low precision are given as the curved surface interpolating level, however, the curved surface interpolating levels according to the present invention are not necessarily limited to those three stages. When a more minute range of references are provided for the interruption frequency and the curved surface interpolating levels respectively corresponding to the range are decided, the interruption frequency can be more flexibly reflected on the operation quantity for the creation of the free curved surface/free curved line. The decision of the curved surface interpolating level and number of the control points may be realized by means of the program that can be stored in and implemented by the memory unit 130 or may be realized based on the external data or the like via the network, or a given method for realizing them can be developed into hardware. Even when the decision of the curved surface interpolating level is developed into the hardware and cannot be changed, the number of the control points can be changed in a different manner by using the program that can be stored in and implemented by the memory unit 130 and the external data or the like via the network as a method for deciding the number of the control points based on the decided curved surface interpolating level.

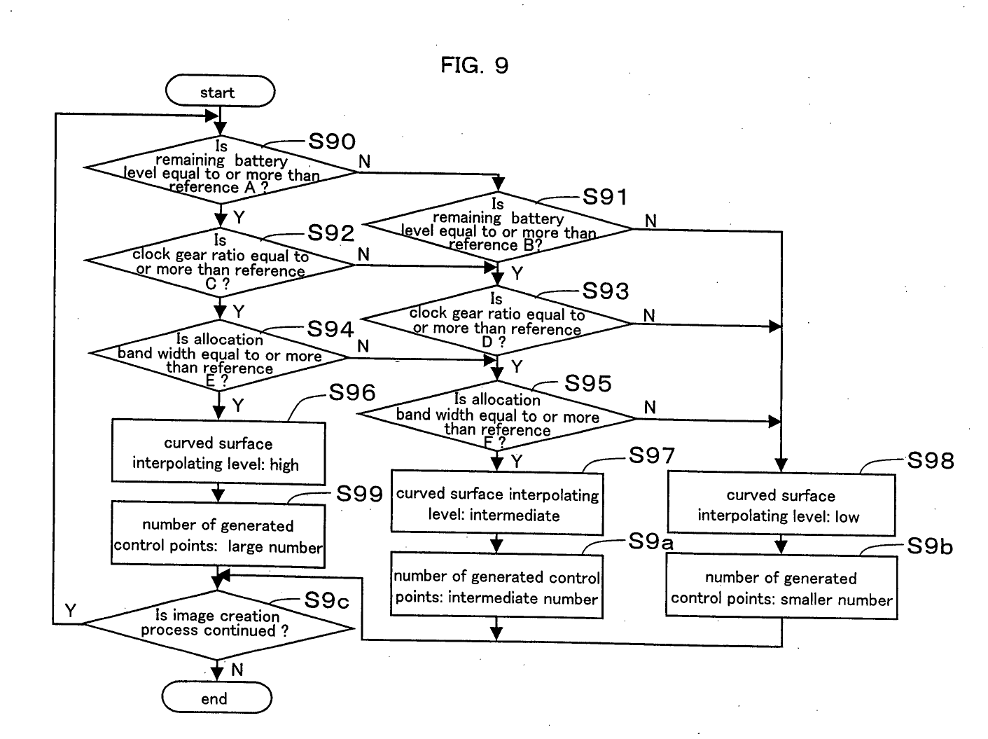

Referring to FIG. 9, which is an example of a process flow according to the present embodiment, a flow of a process, in which the rendering precision of the free curved line is changed by controlling the number of the generated control points depending on three system informations that are the remaining battery level, clock gear ratio and allocation band width, is described.

When the remaining battery level acquired by the system information acquiring unit 120 is equal to or exceeds the reference A, the clock gear ratio acquired by the system information acquiring unit 120 is equal to or exceeds a reference C, and the allocation band width acquired by the system information acquiring unit 120 is equal to or exceeds a reference E (Step S90, S92 and S94), the curved surface interpolating level is set to “high” so that a large number of control points are generated. In such a manner, a highly precise free curved line can be created while the operation quantity is increased (Step S96 and S99).

When the remaining battery level is equal to or exceeds the reference A, the clock gear ratio is equal to or exceeds the reference C, and the allocation band width is equal to or exceeds a reference E and below the reference E (Step S90, S92, S94 and S95); the remaining battery level is equal to or exceeds the reference A, the clock gear ratio is equal to or exceeds a reference D and below the reference C, and the allocation band width is equal to or exceeds the reference F (Step S90, S92, S93 and S95); or the remaining battery level is equal to or exceeds the reference B and below the reference A and the clock gear ratio is equal to or exceeds the reference D and the allocation band width is equal to or exceeds the reference F (Step S90, S91, S93 and S95), the curved surface interpolating level is set to “intermediate” so that an intermediate number of control points are generated. In such a manner, an intermediate-precision free curved line can be created while the operation quantity is reduced in comparison to the operation quantity in the case of the high-precision curved line (Step S97 and S9a).

When the remaining battery level is below the reference B, the clock gear ratio is below the reference D or the allocation band width is below the reference F (Step S91, S93 and S95) the curved surface interpolating level is set to “low” so that a reduced number of control points are generated. Thus, a low-precision free curved line can be created while the operation quantity is further reduced (Step S98 and S9b).

Then, whether or not the image is continuously created within the next image renewal cycle is decided (Step S9c). When it is decided that the image creation continues, the Steps S90-S9b are repeated.

In FIG. 9, the curved surface interpolating level is selected from the three curved surface interpolating levels by means of the judgment steps in which the remaining battery level, clock gear ratio and allocation band width respectively satisfy the reference ranges. However, the types and number of the system informations used for determining the curved surface interpolating level, method for determining the curved surface interpolating level and number of the curved surface interpolating levels are not limited to the foregoing description.

The decision of the curved surface interpolating level may be realized by means of the program that can be stored in and implemented by the memory unit 130 or may be realized based on the external data or the like via the network, or a given method for realizing them can be developed into hardware. Even when the decision of the curved surface interpolating level is developed into the hardware and cannot be changed, the number of the control points can be changed in a different manner by using the program that can be stored in and implemented by the memory unit 130 and the external data or the like via the network as a method for deciding the number of the control points based on the decided curved surface interpolating level.

### Embodiment 2

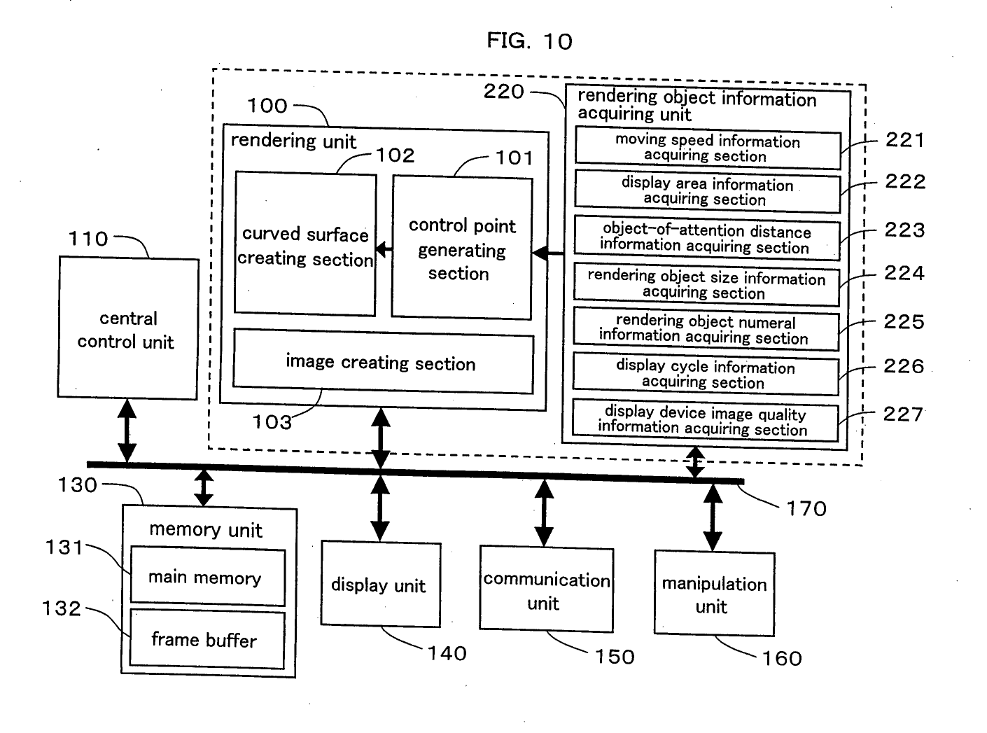

FIG. 10 illustrates an example of a constitution of a rendering device according to an embodiment 2 of the present invention.

The present embodiment necessarily includes at least a rendering unit 100 and a rendering object information acquiring unit 220, and the presence or absence and constitution of any other block are optionally determined. As in the embodiment 1, a central control unit 110 is in charge of the management of an entire system and executes different processes such as instructions to the respective blocks in the system. A memory unit 130 constitutes a work region for the central control unit 110, rendering unit 100 and communication unit 150, and functions as a main memory 131 and a frame buffer 132. A display unit 140 serves to output an image created according to the present embodiment. The communication unit 150 is in charge of communications between the rendering device and an external system via the network or the like.

A program or data according to the present embodiment may adopt such a manner that they are stored in the memory unit 130 or delivered to a control point generating section 101. An manipulation unit 160 is used by the user to manipulate the rendering device.

The rendering object information acquiring unit 220 comprises at least one of a moving speed information acquiring section 221, a display area information acquiring section 222, an object-of-attention distance information acquiring section 223, a rendering object size information acquiring section 224, a rendering object numeral information acquiring section 225, a displayed period information acquiring section 226 and a display device image quality information acquiring section 227.

The moving speed information acquiring section 221 acknowledges a moving speed of a rendering object created in the rendering unit 100, that is a moving distance per unit time.

The display area information acquiring section 222 acknowledges an area where the rendering object created by the rendering unit 100 is rendered when the virtual three-dimensional space (or virtual two-dimensional space) recognized by the user via the display unit 140 is divided into a plurality of areas.

The object-of-attention distance information acquiring section 223 acknowledges a distance relative to a specific object, which the user seems to be closely watching among the rendering objects rendered in the virtual three-dimensional space (or virtual two-dimensional space).

The rendering object size information acquiring section 224 acknowledges a size of the rendering object on the virtual three-dimensional space (or virtual two-dimensional space).

The rendering object numeral information acquiring section 225 acknowledges the number of the rendering objects rendered on the virtual three-dimensional space (or virtual two-dimensional space).

The a displayed period information acquiring section 226 acknowledges a length of time having passed since the user's recognition that the rendering object is rendered by the rendering unit 100 on the display unit 140 and present in the virtual three-dimensional space (or virtual two-dimensional space).

The display device image quality information acquiring section 227 acknowledges an image quality of the display unit 140 based on brightness, contrast, resolution, color gradation and the like which are set in the display unit 140 by the central control unit 110, communication unit 150, manipulation unit 160 and the like or defined as specifications of the display unit 140.

The rendering unit 100 renders, for example, the free curved surface, free curved line and the like based on the central control unit 110 or program. The rendering unit 100 includes the control point generating section 101, curved surface creating section 102 and image creating section 103. The control point generating section 101 executes a process of changing the number of the control points used for the creation of the free curved surface or the free curved line in accordance with at least one of moving speed information of the rendering object, display area information of the rendering object, distance information between the rendering object and the object of attention, numeral information of the rendering object, size information of the rendering object, displayed period information of the rendering object and image quality information of the display unit or a combination thereof, which are acquired by the rendering object information acquiring unit 220.

The control point is the same as described in the embodiment 1.

FIG. 2 is incorporated in the present embodiment by reference. FIGS. 2A, 2B and 2C describe the examples of changing the number of the control points for the creation of the free curved line in accordance with the rendering object information. FIG. 2A shows an image in the case in which it is judged that the free curved line is rendered with a high precision within a predetermined rendering renewal cycle based on the acquired rendering object information. FIG. 2B shows an image in which it is judged to be unnecessary to achieve such a rendering precision that the free curved line of the high precision can be rendered within the predetermined rendering renewal cycle based on the acquired rendering object information and the free curved line is created with an intermediate level of precision. FIG. 2C shows an image in which it is judged to be unnecessary to achieve such a rendering precision that the free curved line of the intermediate precision can be rendered within the predetermined rendering renewal cycle based on the acquired rendering object information and the free curved line is created with a low precision.

In the embodiment 2, the highly precise free curved surface/free curved line is rendered as far as the rendering object information satisfies given conditions even when the image of the same rendering object is created. When the rendering object information fails to satisfy the conditions set for rendering the highly precise free curved surface/free curved line, the precision of the free curved surface/free curved line is changed from the high precision to the intermediate precision or low precision is rendered so that the operation quantity can be changed.

In FIG. 2, the rendering object information is compared to the conditions every time the image is created, however, the curved surface interpolating level in compliance with the system information is not necessarily determined based on the foregoing timing. The number of the control points can be changed, for example, in response to the rendering object information only at a predetermined cycle.

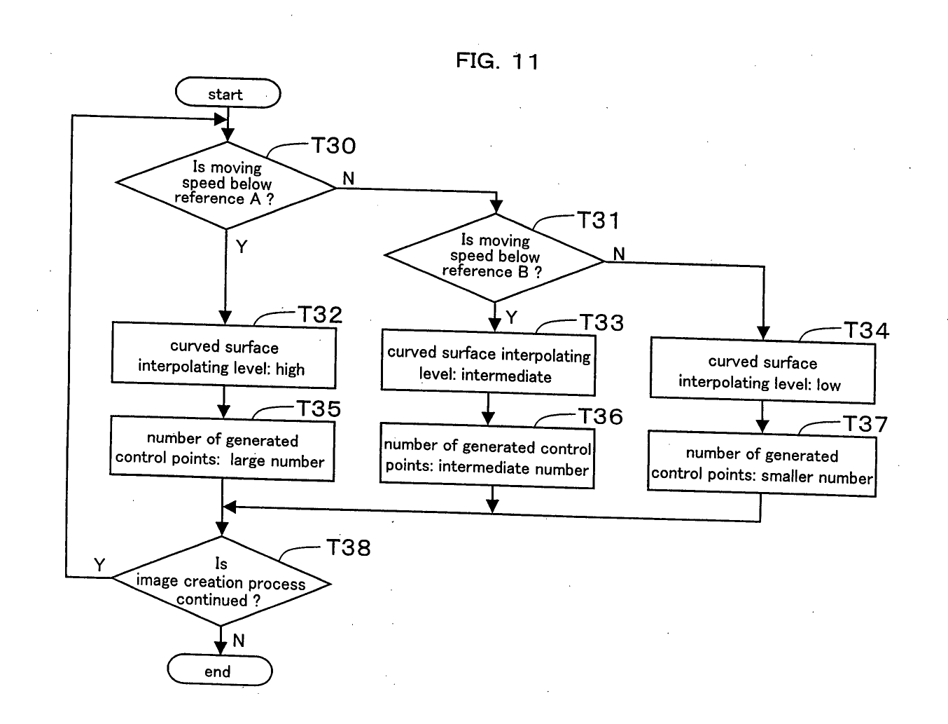

Referring to FIG. 11, which is an example of a process flow according to the present embodiment, a flow of a process, in which the rendering precision of the free curved line is changed by controlling the number of the generated control points depending on the moving speed of the rendering object, is described.

When the moving speed of the rendering object acquired by the rendering object information acquiring unit 220 is below a reference A (slow), the curved surface interpolating level is set to “high” so that a large number of control points are generated. In such a manner, a highly precise free curved line can be created while the operation quantity is increased (Step T30, T32 and T35).

When the moving speed of the rendering object is equal to or exceeds the reference A and below a reference B, the curved surface interpolating level is set to “intermediate” so that an intermediate number of control points are generated. In such a manner, an intermediate-precision free curved line can be created while the operation quantity is reduced in comparison to the operation quantity in the case of high-precision free curved line (Step T30, T31, T33 and T36).

When the moving speed of the rendering object is equal to or exceeds the reference B (fast), the curved surface interpolating level is set to “low” so that a smaller number of control points are generated. Thus, a low-precision free curved line can be created while the operation quantity is further reduced (Step T30, T31, T34 and T37).

Then, whether or not the image is continuously created within a next image renewal cycle is decided (Step T38). When it is decided that the image creation continues, the Steps T30-T37 are repeated.

In FIG. 11, the three stages of the high precision, intermediate precision and low precision are given as the curved surface interpolating level, however, the curved surface interpolating levels according to the present invention are not necessarily limited to those three stages. When a more minute range of references are provided for the moving speed of the rendering object and the curved surface interpolating levels respectively corresponding to the range are decided, the moving speed of the rendering object can be more flexibly reflected on the operation quantity for the creation of the free curved surface/free curved line.

The decision of the curved surface interpolating level and number of the control points may be realized by means of the program that can be stored in and implemented by the memory unit 130 or may be realized based on the external data or the like via the network, or a given method for realizing them can be developed into hardware. Even when the decision of the curved surface interpolating level is developed into the hardware and cannot be changed, the number of the control points can be changed in a different manner by using the program that can be stored in and implemented by the memory unit 130 and the external data or the like via the network as a method for deciding the number of the control points based on the decided curved surface interpolating level.

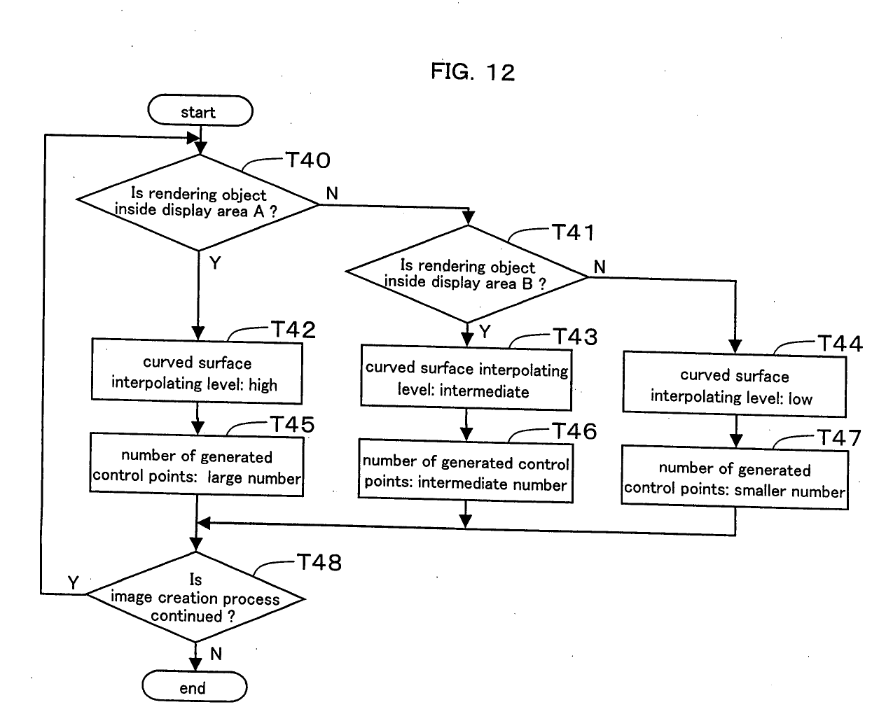

Referring to FIG. 12, which is an example of a process flow according to the present embodiment, a flow of a process, in which the rendering precision of the free curved line is changed by controlling the number of the generated control points depending on the display area information of the rendering object, is described.

When an area where the rendering object is rendered according to the display area information acquired by the rendering object information acquiring unit 220 is A, the curved surface interpolating level is set to “high” so that a large number of control points are generated. In such a manner, a highly precise free curved line can be created while the operation quantity is increased (Step T40, T42 and T45).

When the area where the rendering object is rendered is B, the curved surface interpolating level is set to “intermediate” so that an intermediate number of control points are generated. In such a manner, an intermediate-precision free curved line can be created while the operation quantity is reduced in comparison to the operation quantity in the case of the high-precision curved line (Step T40, T41, T43 and T46).

When the area where the rendering object is rendered is C, the curved surface interpolating level is set to “low” so that a smaller number of control points are generated. Thus, a low-precision free curved line can be created while the operation quantity is further reduced (Step T40, T41, T44 and T47).

Then, whether or not the image is continuously created within the next image renewal cycle is decided (Step T48). When it is decided that the image creation continues, the Steps T40-T47 are repeated.

In FIG. 12, the three stages of the high precision, intermediate precision and low precision are given as the curved surface interpolating level, however, the curved surface interpolating levels according to the present invention are not necessarily limited to those three stages. When a more minute range of references are provided for the display area of the rendering object and the curved surface interpolating levels respectively corresponding to the range are decided, the display area of the rendering object can be more flexibly reflected on the operation quantity for the creation of the free curved surface/free curved line.

The decision of the curved surface interpolating level and number of the control points may be realized by means of the program that can be stored in and implemented by the memory unit 130 or may be realized based on an external data or the like via the network, or a given method for realizing them can be developed into hardware. Even when the decision of the curved surface interpolating level is developed into the hardware and cannot be changed, the number of the control points can be changed in a different manner by using the program that can be stored in and implemented by the memory unit 130 and the external data or the like via the network as a method for deciding the number of the control points based on the decided curved surface interpolating level.

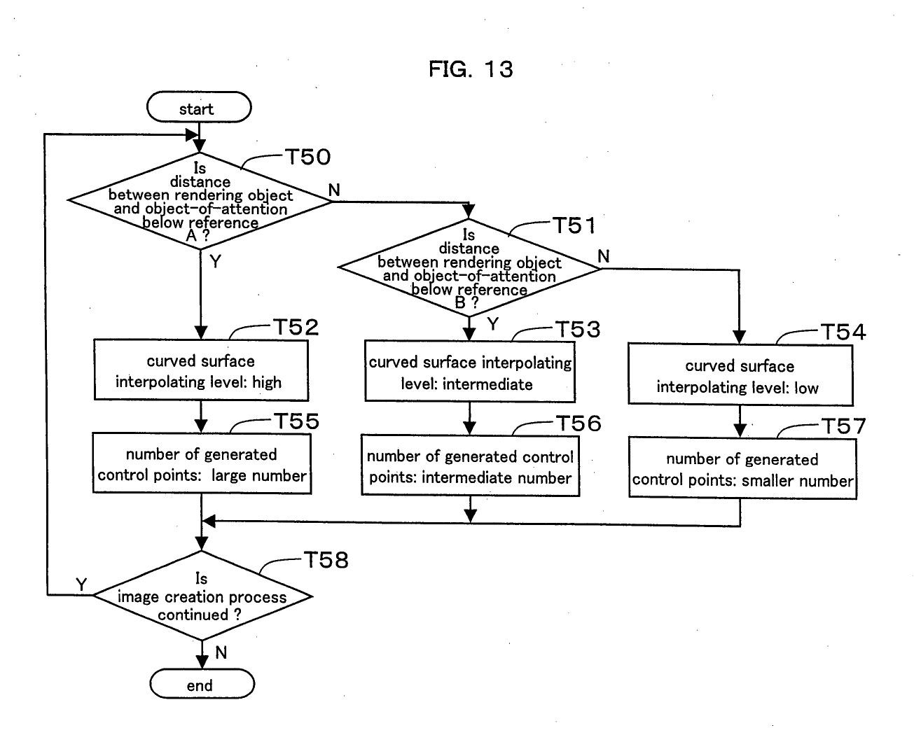

Referring to FIG. 13, which is an example of a process flow according to the present embodiment, a flow of a process, in which the rendering precision of the free curved line is changed by controlling the number of the generated control points depending on the distance between the rendering object and the object of attention, is described.

When the distance between the rendering object and the object of attention acquired by the rendering object information acquiring unit 220 is below a reference A (close), the curved surface interpolating level is set to “high” so that a large number of control points are generated. In such a manner, a highly precise free curved line can be created while the operation quantity is increased (Step T50, T52 and T55).

When the distance between the rendering object and the object of attention is equal to or exceeds the reference A and below a reference B, the curved surface interpolating level is set to “intermediate” so that an intermediate number of control points are generated. In such a manner, an intermediate-precision free curved line can be created while the operation quantity is reduced in comparison to the operation quantity in the case of the high-precision curved line (Step T50, T51, T53 and T56).

When the distance between the rendering object and the object of attention is equal to or exceeds the reference B (distant), the curved surface interpolating level is set to “low” so that a smaller number of control points are generated. Thus, a low-precision free curved line can be created while the operation quantity is further reduced (Step T50, T51, T54 and T57).

Then, whether or not the image is continuously created within the next image renewal cycle is decided (Step T58). When it is decided that the image creation continues, the Steps T50-T57 are repeated.

In FIG. 13, the three stages of the high precision, intermediate precision and low precision are given as the curved surface interpolating level, however, the curved surface interpolating levels according to the present invention are not necessarily limited to those three stages. When a more minute range of references are provided for the distance relative to the object of attention and the curved surface interpolating levels respectively corresponding to the range are decided, the distance relative to the object of attention can be more flexibly reflected on the operation quantity for the creation of the free curved surface/free curved line.

The decision of the curved surface interpolating level and number of the control points may be realized by means of the program that can be stored in and implemented by the memory unit 130 or may be realized based on the external data or the like via the network, or a given method for realizing them can be developed into hardware. Even when the decision of the curved surface interpolating level is developed into the hardware and cannot be changed, the number of the control points can be changed in a different manner by using the program that can be stored in and implemented by the memory unit 130 and the external data or the like via the network as a method for deciding the number of the control points based on the decided curved surface interpolating level.

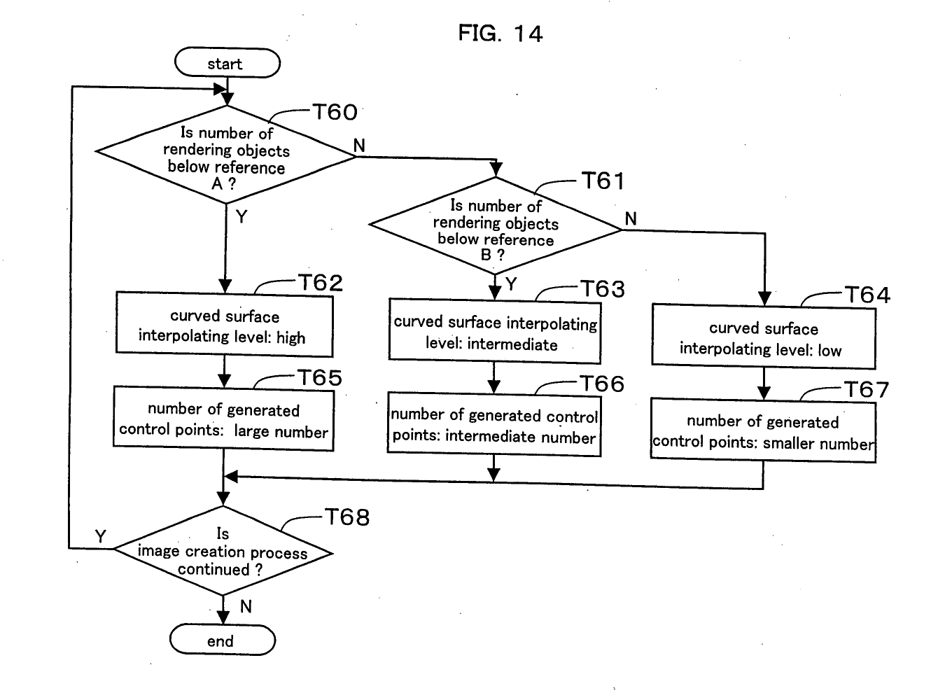

Referring to FIG. 14, which is an example of a process flow according to the present embodiment, a flow of a process; in which the rendering precision of the free curved line is changed by controlling the number of the generated control points depending on the numeral information of the rendering object, is described.

When the number of the rendering objects according to the numeral information acquired by the rendering object information acquiring unit 220 is below a reference A, the curved surface interpolating level is set to “high” so that a large number of control points are generated. In such a manner, a highly precise free curved line can be created while the operation quantity is increased (Step T60, T62 and T65).

When the number of the rendering objects is equal to or exceeds the reference A and below a reference B, the curved surface interpolating level is set to “intermediate” so that an intermediate number of control points are generated. In such a manner, an intermediate-precision free curved line can be created while the operation quantity is reduced in comparison to the operation quantity in the case of the free curved line of the high precision (Step T60, T61, T63 and T66).

When the number of the rendering objects is equal to or exceeds the reference B, the curved surface interpolating level is set to “low” so that a smaller number of control points are generated. Thus, a low-precision free curved line can be created while the operation quantity is further reduced (Step T60, T61, T64 and T67).

Then, whether or not the image is continuously created within the next image renewal cycle is decided (Step T68). When it is decided that the image creation continues, the Steps T60-T67 are repeated.

In FIG. 14, the three stages of the high precision, intermediate precision and low precision are given as the curved surface interpolating level, however, the curved surface interpolating levels according to the present invention are not necessarily limited to those three stages. When a more minute range of references are provided for the number of the rendering objects and the curved surface interpolating levels respectively corresponding to the range are decided, the number of the rendering objects can be more flexibly reflected on the operation quantity for the creation of the free curved surface/free curved line.

The decision of the curved surface interpolating level and number of the control points may be realized by means of the program that can be stored in and implemented by the memory unit 130 or may be realized based on an external data or the like via the network, or a given method for realizing them can be developed into hardware. Even when the decision of the curved surface interpolating level is developed into the hardware and cannot be changed, the number of the control points can be changed in a different manner by using the program that can be stored in and implemented by the memory unit 130 and the external data or the like via the network as a method for deciding the number of the control points based on the decided curved surface interpolating level. Examples of a method for detecting the number of the rendering objects includes, for example, a method in which a representative point selected based on given conditions in the rendering object is counted by a counter, and the like.

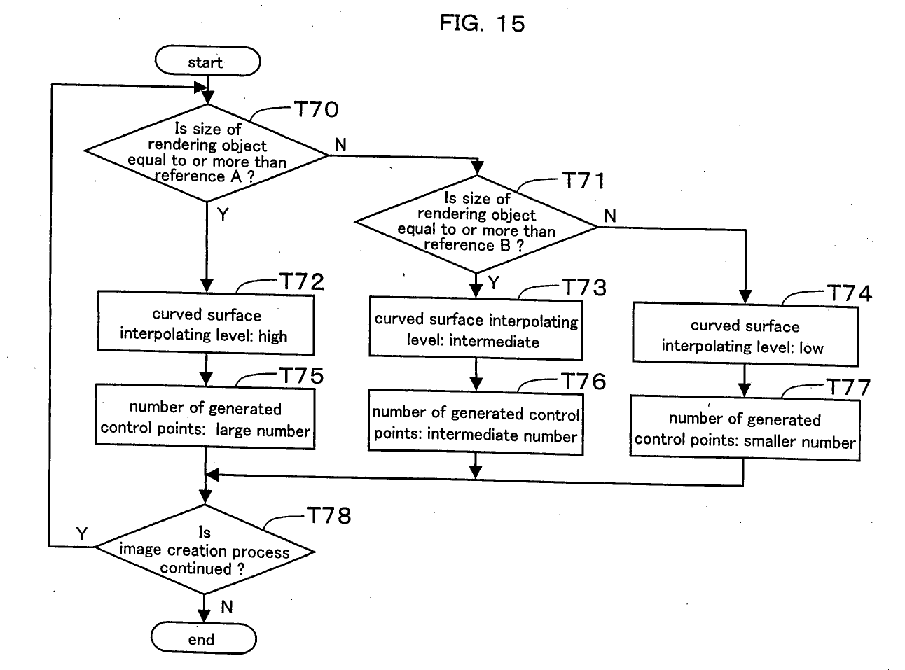

Referring to FIG. 15, which is an example of a process flow according to the present embodiment, a flow of a process, in which the rendering precision of the free curved line is changed by controlling the number of the generated control points depending on the size information of the rendering object, is described.

When the size of the rendering object acquired by the rendering object information acquiring unit 220 is equal to or exceeds a reference A, the curved surface interpolating level is set to “high” so that a large number of control points are generated. In such a manner, a highly precise free curved line can be created while the operation quantity is increased (Step. T70, T72 and T75).

When the size of the rendering object is equal to or exceeds a reference B and below the reference A, the curved surface interpolating level is set to “intermediate” so that an intermediate number of control points are generated. In such a manner, an intermediate-precision free curved line can be created while the operation quantity is reduced in comparison to the operation quantity in the case of the free curved line of the high precision (Step T70, T71, T73 and T76).

When the size of the rendering object is below the reference B, the curved surface interpolating level is set to “low” so that a smaller number of control points are generated. Thus, a low-precision free curved line can be created while the operation quantity is further reduced (Step T70, T71, T74 and T77).

Then, whether or not the image is continuously created within the next image renewal cycle is decided (Step T78). When it is decided that the image creation continues, the Steps T70-T77 are repeated.

In FIG. 15, the three stages of the high precision, intermediate precision and low precision are given as the curved surface interpolating level, however, the curved surface interpolating levels according to the present invention are not necessarily limited to those three stages. When a more minute range of references are provided for the size of the rendering object and the curved surface interpolating levels respectively corresponding to the range are decided, the size of the rendering object can be more flexibly reflected on the operation quantity for the creation of the free curved surface/free curved line.

The decision of the curved surface interpolating level and number of the control points may be realized by means of the program that can be stored in and implemented by the memory unit 130 or may be realized based on the external data or the like via the network, or a given method for realizing them can be developed into hardware. Even when the decision of the curved surface interpolating level is developed into the hardware and cannot be changed, the number of the control points can be changed in a different manner by using the program that can be stored in and implemented by the memory unit 130 and the external data or the like via the network as a method for deciding the number of the control points based on the decided curved surface interpolating level.

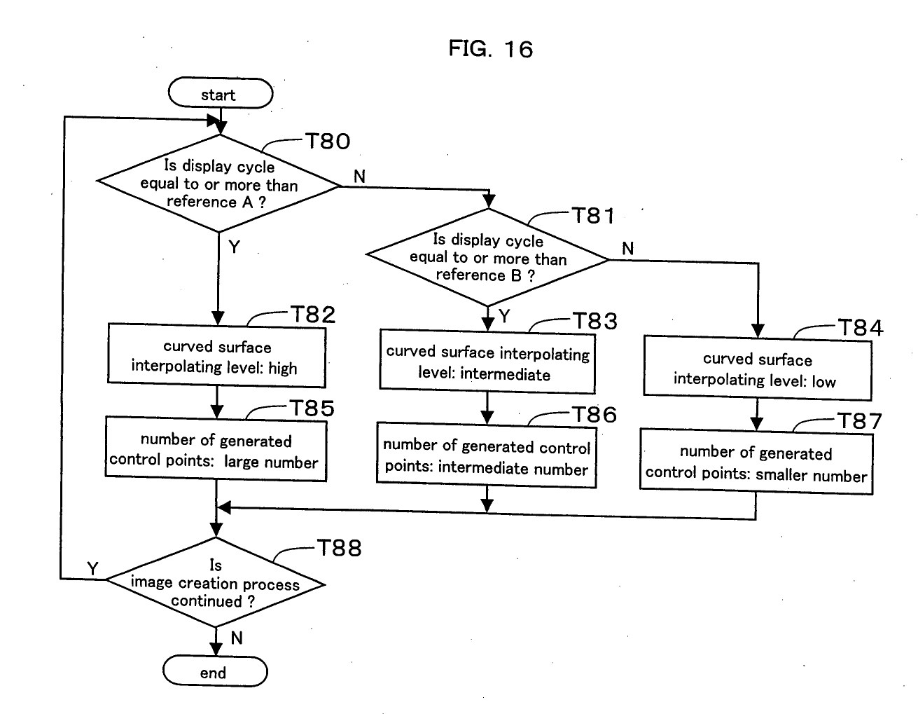

Referring to FIG. 16, which is an example of a process flow according to the present embodiment, a flow of a process, in which the rendering precision of the free curved line is changed by controlling the number of the generated control points depending on the displayed period information of the rendering object, is described.

When the displayed period of the rendering object acquired by the rendering object information acquiring unit 220 is equal to or exceeds a reference A, the curved surface interpolating level is set to “high” so that a large number of control points are generated. In such a manner, a highly precise free curved line can be created while the operation quantity is increased (Step T80, T82 and T85).

When the displayed period of the rendering object is below the reference A and equal to or exceeds a reference B, the curved surface interpolating level is set to “intermediate” so that an intermediate number of control points are generated. In such a manner, an intermediate-precision free curved line can be created while the operation quantity is reduced in comparison to the operation quantity in the case of the free curved line of the high precision (Step T80, T81, T83 and T86).

When the displayed period of the rendering object is below the reference B, the curved surface interpolating level is set to “low” so that a smaller number of control points are generated. Thus, a low-precision free curved line can be created, though the operation quantity is reduced (Step T80, T81, T84 and T87).

Then, whether or not the image is continuously created within a next image renewal cycle is decided (Step T88). When it is decided that the image creation continues, the Steps T80-T87 are repeated.

In FIG. 16, the three stages of the high precision, intermediate precision and low precision are provided as the curved surface interpolating level, however, the curved surface interpolating levels according to the present invention are not necessarily limited to those three stages. When a more minute range of references are provided for the displayed period of the rendering object and the curved surface interpolating levels respectively corresponding to the range are decided, the displayed period of the rendering object can be more flexibly reflected on the operation quantity for the creation of the free curved surface/free curved line.

The decision of the curved surface interpolating level and number of the control points may be realized by means of the program that can be stored in and implemented by the memory unit 130 or may be realized based on the external data or the like via the network, or a given method for realizing them can be developed into hardware. Even when the decision of the curved surface interpolating level is developed into the hardware and cannot be changed, the number of the control points can be changed in a different manner by using the program that can be stored in and implemented by the memory unit 130 and the external data or the like via the network as a method for deciding the number of the control points based on the decided curved surface interpolating level. Examples of a method for detecting the displayed period includes, for example, a method in which a count number is incremented by a counter for each certain screen renewal cycle starting at a time point when the representative point selected in the rendering object based on the given conditions is disposed in the display area (inside of the frame buffer or the like), and the like.

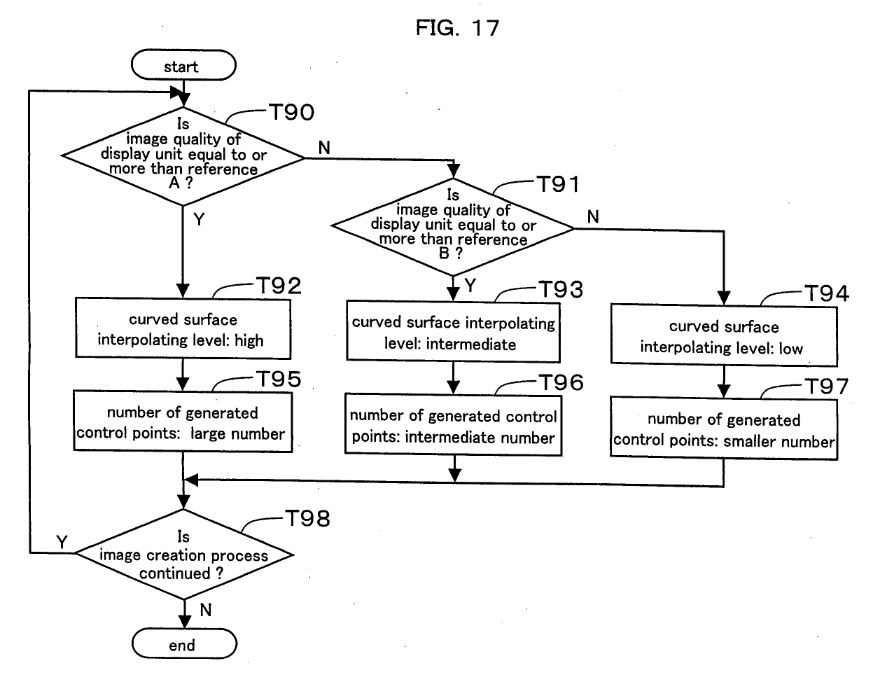

Referring to FIG. 17, which is an example of a process flow according to the present embodiment, a flow of a process, in which the rendering precision of the free curved line is changed by controlling the number of the generated control points depending on the image quality information of the display unit, is described.

When the image quality of the display unit acquired by the rendering object information acquiring unit 220 is equal to or exceeds a reference A, the curved surface interpolating level is set to “high” so that a large number of control points are generated. In such a manner, a highly precise free curved line can be created while the operation quantity is increased (Step T90, T92 and T95).

When the image quality of the display unit is below the reference A and equal to or exceeds a reference B, the curved surface interpolating level is set to “intermediate” so that an intermediate number of control points are generated. In such a manner, an intermediate-precision free curved line can be created while the operation quantity is reduced in comparison to the operation quantity in the case of the free curved line of the high precision (Step T90, T91, T93 and T96).

When the image quality of the display unit is below the reference B, the curved surface interpolating level is set to “low” so that a smaller number of control points are generated. Thus, a low-precision free curved line can be created while the operation quantity is further reduced (Step T90, T91, T94 and T97).

Then, whether or not the image is continuously created within the next image renewal cycle is decided (Step T98). When it is decided that the image creation continues, the Steps T90-T97 are repeated.

In FIG. 17 the three stages of the high precision, intermediate precision and low precision are given as the curved surface interpolating level, however, the curved surface interpolating levels according to the present invention are not necessarily limited to those three stages. When a more minute range of references are provided for the image quality of the display unit and the curved surface interpolating levels respectively corresponding to the range are decided, the image quality of the display unit can be more flexibly reflected on the operation quantity for the creation of the free curved surface/free curved line.

The decision of the curved surface interpolating level and number of the control points may be realized by means of the program that can be stored in and implemented by the memory unit 130 or may be realized based on the external data or the like via the network, or a given method for realizing them can be developed into hardware. Even when the decision of the curved surface interpolating level is developed into the hardware and cannot be changed, the number of the control points can be changed in a different manner by using the program that can be stored in and implemented by the memory unit 130 and the external data or the like via the network as a method for deciding the number of the control points based on the decided curved surface interpolating level.

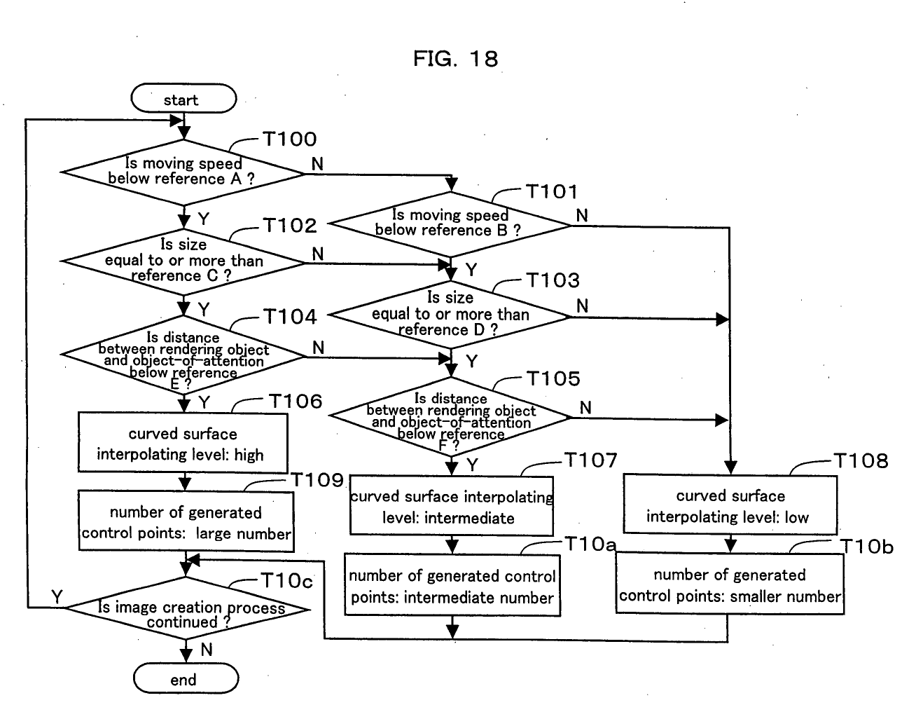

Referring to FIG. 18, which is an example of a process flow according to the present embodiment, a flow of a process, in which the rendering precision of the free curved line is changed by controlling the number of the generated control points depending on three rendering object informations that are the moving speed of the rendering object, area where the rendering object is rendered and distance relative to the object of attention, is described.

When the moving speed of the rendering object acquired by the rendering object information acquiring unit 220 is below the reference A, the size of the rendering object is equal to or exceeds a reference C and the distance relative to the object of attention is below a reference E (Step T100, T102 and T104), the curved surface interpolating level is set to “high” so that a large number of control points aregenerated. In such a manner, a highly precise free curved line can be created while the operation quantity is increased (Step T106 and T109).

When any of the followings, a), b) and c), is satisfied, the curved surface interpolating level is set to “intermediate” so that an intermediate number of control points are generated. In such a manner, an intermediate-precision free curved line can be created while the operation quantity is reduced in comparison to the operation quantity in the case of the free curved line of the high precision (Step T107 and T10a).

a) When the moving speed of the rendering object is below the reference A, the size of the rendering object is equal to or exceeds the reference C and the distance relative to the object of attention is equal to or exceeds the reference E and below a reference F (Step T100, T102, T104 and T105);
b) When the moving speed of the rendering object is below the reference A, the size of the rendering object is equal to or exceeds a reference D and below the reference C and the distance relative to the object of attention is below the reference F (T100, T102, T103 and T105); and
c) When the moving speed of the rendering object is equal to or exceeds the reference A and below the reference B, the size of the rendering object is equal to or exceeds the reference D and the distance relative to the object of attention is below the reference F (T100, T101, T103 and T105)

When the moving speed of the rendering object is equal to or exceeds the reference B, the size of the rendering object is below the reference D, or the distance relative to the object of attention is equal to or exceeds the reference F (T101, T103 and T105), the curved surface interpolating level is set to “low” so that a smaller number of control points are generated. Thus, a low-precision free curved line can be create while the operation quantity is reduced (Step T108 and T10b).

Then, whether or not the image is continuously created within the next image renewal cycle is decided (Step T10c). When it is decided that the image creation continues, the Steps T100-0T10b are repeated.

In FIG. 18, the curved surface interpolating level is determined from the three curved surface interpolating levels by means of the judgment steps in which the moving speed of the rendering object, size of the rendering object and distance relative to the object of attention respectively satisfy the reference ranges. However, the types and number of the rendering object information used for determining the curved surface interpolating level, method for determining the curved surface interpolating level and number of the curved surface interpolating levels are not limited the foregoing description.

The decision of the curved surface interpolating level may be realized by means of the program that can be stored in and implemented by the memory unit 130 or may be realized based on the external data or the like via the network, or a given method for realizing them can be developed into hardware. Even when the decision of the curved surface interpolating level is developed into the hardware and cannot be changed, the number of the control points can be changed in a different manner by using the program that can be stored in and implemented by the memory unit 130 and the external data or the like via the network as a method for deciding the number of the control points based on the decided curved surface interpolating level.

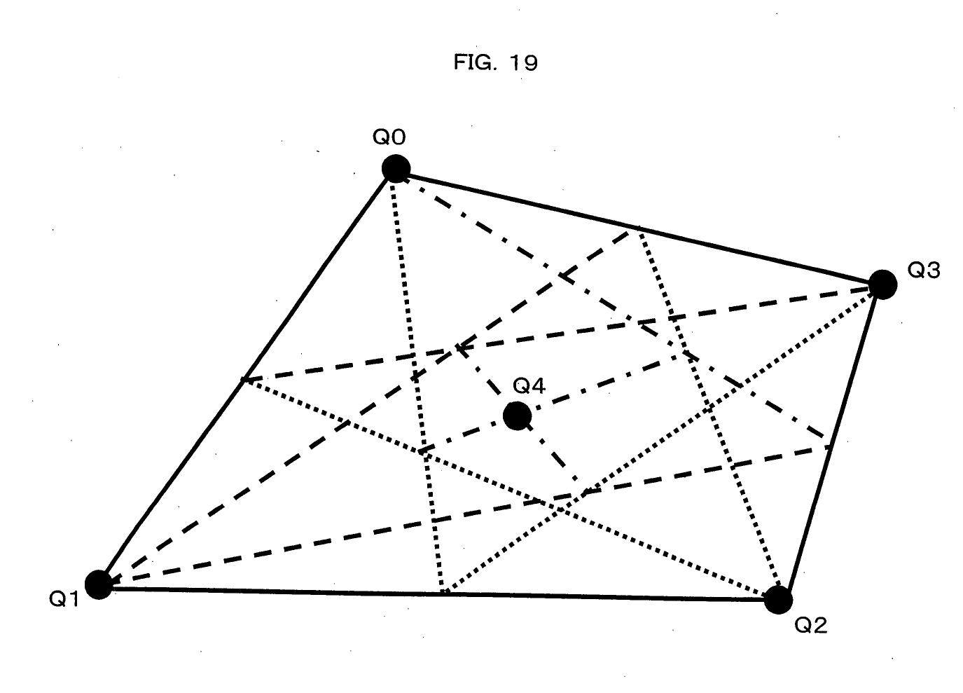

FIG. 19 illustrates a method in which a center of gravity of a polygon shaped by the control points used when the free curved surface/free curved line is rendered with a minimum precision serves as a representative point of the rendering object, which represents an example of a method for deciding the representative point of the rendering object used when the rendering object information is any of the moving speed of the rendering object, display area information of the rendering object, distance information between the rendering object and the object of attention, numeral information of the rendering object and displayed period information of the rendering object.

In FIG. 19, the polygon shaped by four points (Q0, Q1, Q2 and Q3), which are the points used when the free curved surface/free curved line is rendered with the minimum precision, is diagonally cut into triangles so as to obtain the center of gravity (Q4). The center of gravity may be obtained through some other method such as a calculation method using a position vector. The center of gravity may be determined by means of the program that can be stored in and implemented by the memory unit 130 or may be determined based on the external data or the like via the network, or a given method for determining it can be developed into hardware.

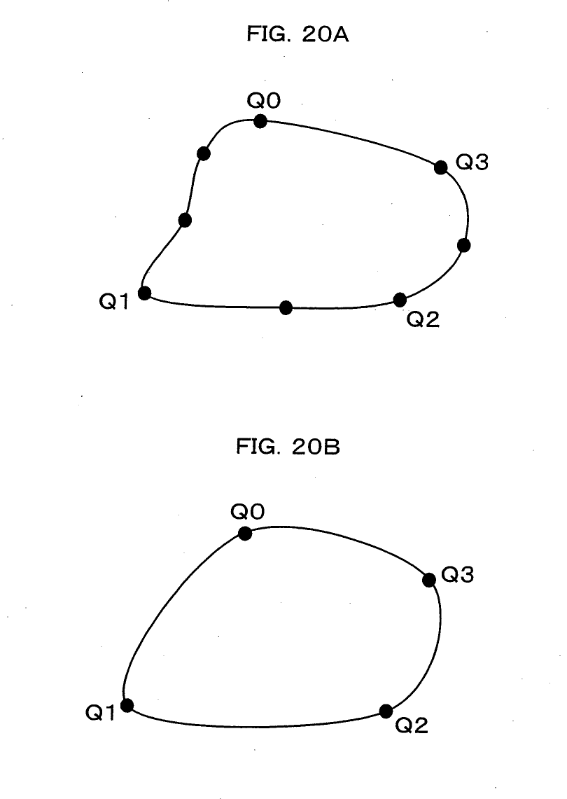

FIG. 20 illustrates a method in which a point selected under given conditions from the control points used when the free curved surface/free curved line is rendered with the minimum precision serves as a representative point of the rendering object, which represents an example of the method for deciding the representative point of the rendering object used-when the rendering object information is any of the moving speed of the rendering object, display area information of the rendering object, distance information between the rendering object and the object of attention, numeral information of the rendering object and displayed period information of the rendering object. In the shown example, all of the control points (Q0, Q1, Q2 and Q3) common in the creation of any free curved line, from FIG. 20A in which the free curved line is rendered with a maximum precision to FIG. 20B in which the free curved line is rendered with the minimum precision, serve as the representative points. The representative point, however, may be part of the control points used in the minimum-precision rendering. The representative point may be determined from the minimum-precision control points by means of the program that can be stored in and implemented by the memory unit 130 or may be determined based on the external data or the like via the network, or a given method for determining it can be developed into hardware.

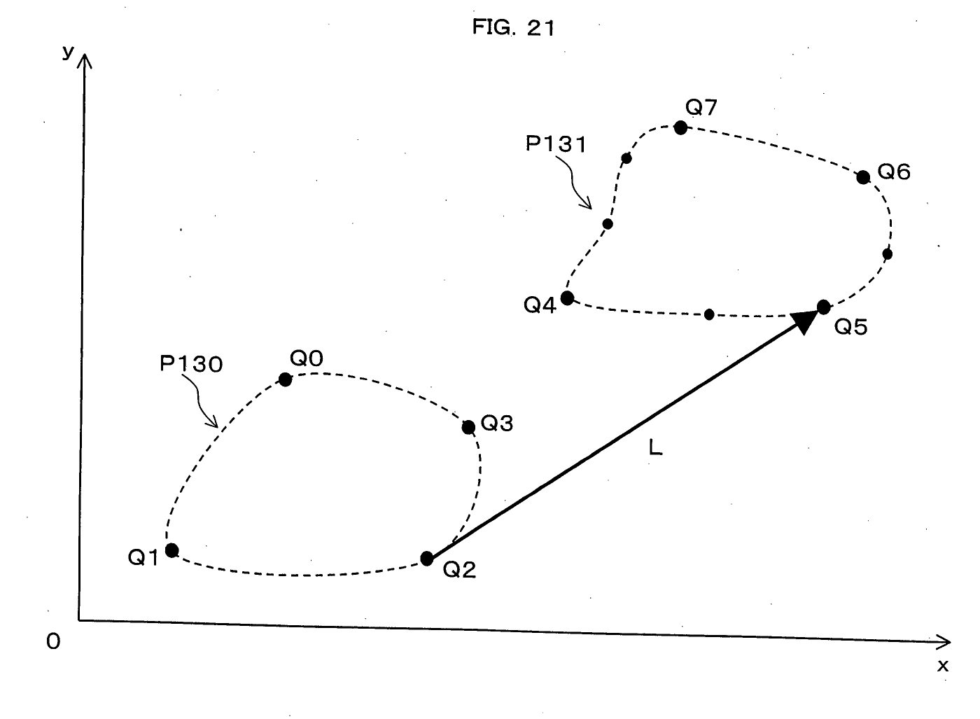

FIG. 21 illustrates an example of the detection of a distance used when the rendering object information is one of the moving speed information of the rendering object and the distance information between the rendering object and the object of attention using a linear distance between the representative points of the rendering objects. A representative point of a rendering object P130 is Q2, a representative point of a rendering object P131 is Q5 and a linear distance L between the two points is a linear distance between the rendering objects P130 and P131.

In FIG. 21, as the representative points of the rendering objects P130 and P131, one representative point is selected for each object from the control points used for rendering the free curved surface/free curved line of the minimum precision under given conditions. However, the selection of the representative point is not limited to such a manner. In FIG. 21, only the distance between the two points in an x-y direction is shown, however, the distance may include a depth direction. The distance between the representative points may be calculated by means of the program that can be stored in and implemented by the memory unit 130 or may be calculated based on the external data or the like via the network, or a given method for calculating it can be developed into hardware.

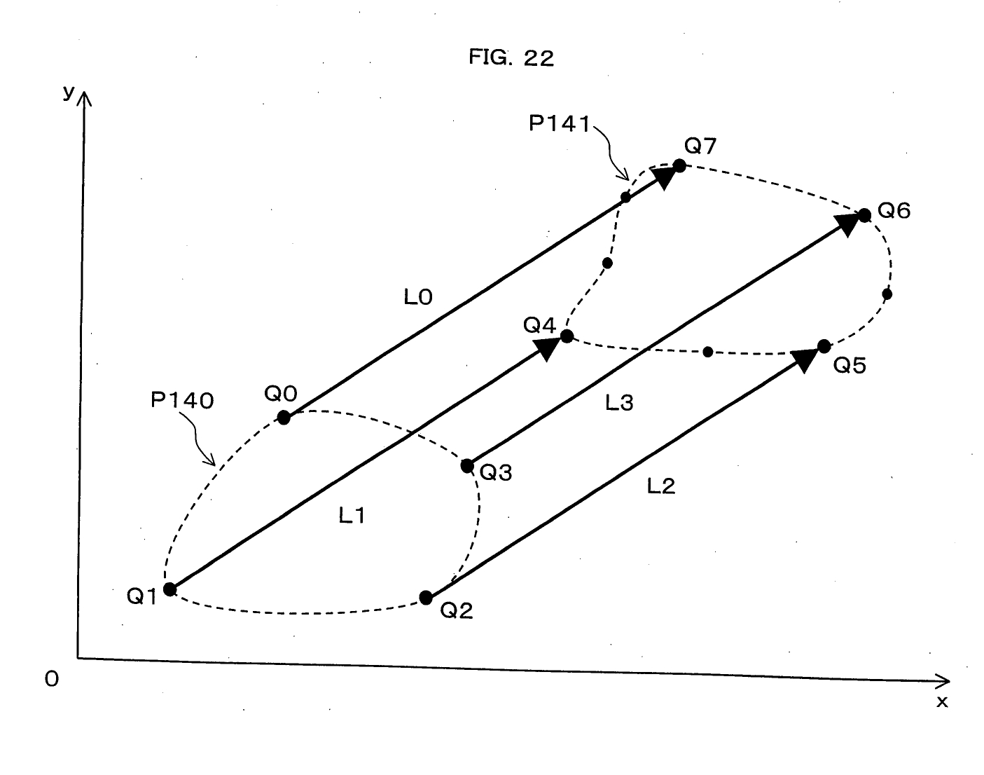

FIG. 22 illustrates an example of detection of a distance used when the rendering object information is one of the moving speed information of the rendering object and the distance information between the rendering object and the object of attention using an average value of linear distances between the representative points of the rendering object in the case in which the rendering object has a plurality of representative points. Representative points of a rendering object P140 are Q0, Q1, Q2 and Q3, representative points of a rendering object P141 are Q4, Q5, Q6 and Q7, and an average value L of a linear distance L0 between Q0 and Q7, a linear distance L1 between Q1 and Q4, a linear distance L2 between Q2 and Q5 and a linear distance L3 between Q3 and Q6 (=(L0+L1+L2+L3)/4) is a linear distance between the rendering objects P140 and 141.

In FIG. 22, the four points are selected from the control points used for rendering the free curved surface/free curved line of the minimum precision under given conditions as the representative points of the rendering objects P140 and 0141, however, the representative point may be selected in a different manner. In FIG. 22, only the distance between the two points in an x-y direction is shown, however, the distance may include a depth direction. The association of the representative points between the rendering objects, calculation of the distance between the representative points and calculation of the average distance may be realized by means of the program that can be stored in and implemented by the memory unit 130 or may be realized based on the external data or the like via the network, or a given method for realizing them can be developed into hardware.

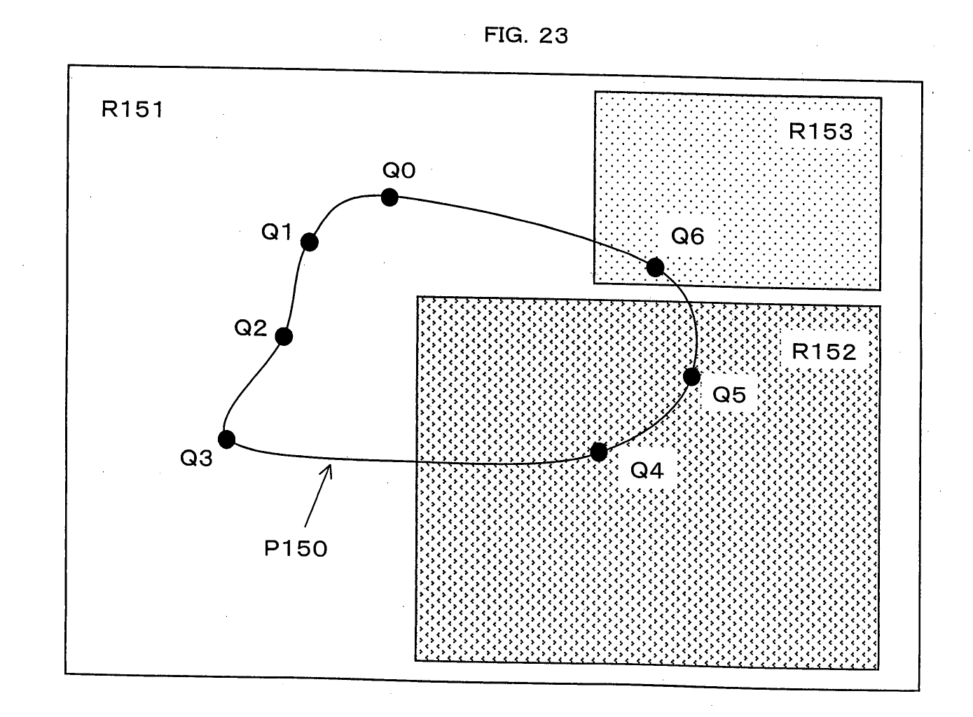

FIG. 23 illustrates an example of setting of an average value of the curved surface interpolating levels respectively set in the display areas to which the representative points belong as the curved surface interpolating level of the rendering object, which represents a method for determining the curved surface interpolating level in the case in which the rendering object has a plurality of representative points when the rendering object information is the display area information of the rendering object. When representative points of a rendering object P150 are seven points from Q0 to Q6, the representative points Q0, Q1, Q2 and Q3 belong to a display area R151, the representative points Q4 and Q5 belong to a display area R152, and the representative point Q6 belong to a display area R153. A curved surface interpolating level of the display area R151 is A, a curved surface interpolating level of the display area R152 is B, and a curved surface interpolating level of the display area R153 is C, an average value D of the curved surface interpolating levels A, B and C of the display areas to which the representative points Q0-Q6 belong, that is (A*4+B*2+C*1)/7, is set as a curved surf ace interpolating level of the rendering object P150.

When the average value D does not reach a previously set value of the curved surface interpolating level, a curved surface interpolating level closest to the previously set value is set as the curved surface interpolating level of the rendering object.

The calculation of the average value of the curved surf ace interpolating levels may be realized by means of the program that can be stored in and implemented by the memory unit 130 or may be realized based on the external data or the like via the network, or a given method for realizing it can be developed into hardware.

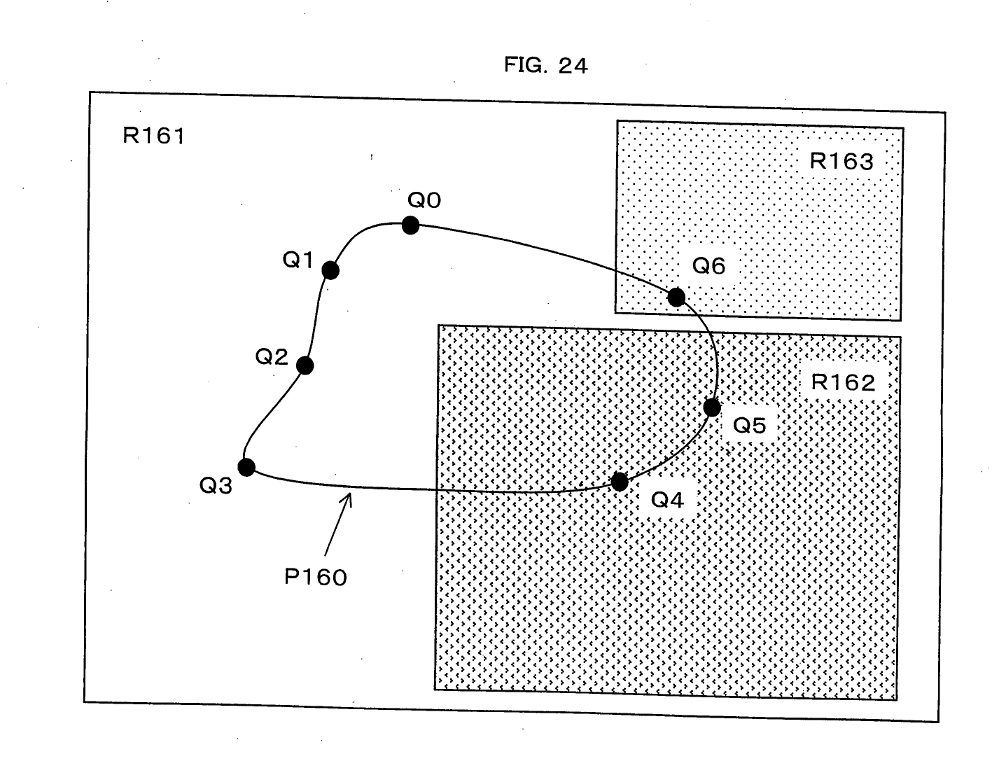

FIG. 24 illustrates an example of setting of the number of the control points generated in accordance with the curved surface interpolating levels respectively set in the display areas to which the representative points, belong, which represents the method for determining the curved surface interpolating level in the case in which the rendering object has a plurality of representative points when the rendering object information is the display area information of the rendering object.

When representative points of a rendering object P160 are seven points from Q0 to Q6, the representative points Q0, Q1, Q2 and Q3 belong to a display area R161, the representative points Q4 and Q5 belong to a display area R162, and the representative point Q6 belongs to a display area R163. When a curved surface interpolating level of the display area R161 is A, a curved surface interpolating level of the display area R162 is B, and a curved surface interpolating level of the display area R163 is C, whether or not the representative points Q1, Q2 and Q3 are generated in the next screen renewal cycle is decided in accordance with the curved surface interpolating level A, whether or not the representative points Q4 and Q5 are generated in the next screen renewal cycle is decided in accordance with the curved surface interpolating level B, and whether or not the representative point Q6 is generated in the next screen renewal cycle is decided in accordance with the curved surface interpolating level C. As an alternative method, any control point, which is not generated in the stage of determining the curved surface interpolating level, may conform to a curved surface interpolating level of a control point in close vicinity

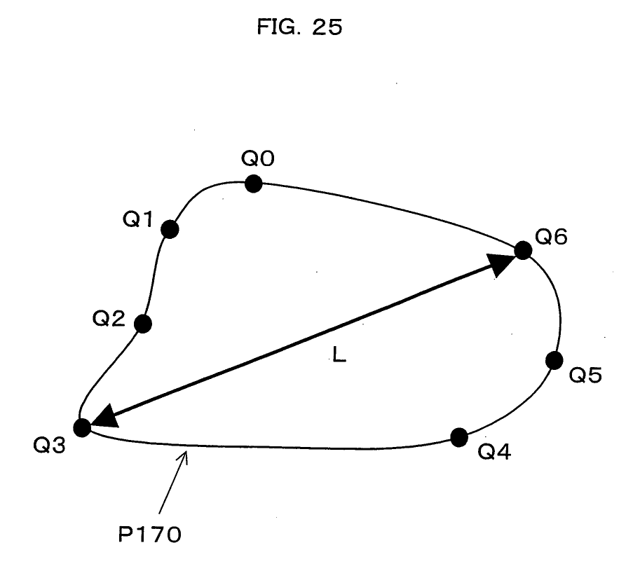

FIG. 25 is an example of using a distance between the two control points used when the free curved line is rendered with the minimum precision as a size of the rendering object, which represents a method for detecting the size of the rendering object used when the rendering object information is one of the size information of the rendering object and the distance information between the rendering object and the object of attention. When control points used in rendering a rendering object P170 is rendered with the minimum precision are seven points from Q0 to Q6, a linear distance L between the two points Q3 and Q6 selected under given conditions is set as a size of the rendering object P170.

The selection of the two control points used for judging the size and calculation of the linear distance between the two points may be realized by means of the program that can be stored in and implemented by the memory unit 130 or may be realized based on the external data or the like via the network, or a given method for realizing them can be developed into hardware. When the rendering object information is the distance information between the rendering object and the object of attention, as a method for selecting the object of attention, the rendering object whose size satisfies the given conditions may be used as the object of attention.

Whether or not the size of the rendering object satisfies the conditions set for the object of attention may be judged by means of the program that can be stored in and implemented by the memory unit 130 or may be judged based on the external data or the like via the network, or a given method for judging it can be developed into hardware

As thus far described, according to the present invention, the number of the control points for determining the shape of the free curved surface/free curved line can be changed in compliance with the system statuses and operation performance, and the free curved surface/free curved line can be created based on the changed number of control points. Therefore, the free curved surface/free curved line can be created achieving an optimum rendering quality in compliance with the system statuses.

For example, the free curved surface/free curved line achieving a highest precision in all the free curved surfaces/free curved lines creatable without causing any problem can be selectively created by generating a largest number of control points by which the rendering process can be completed in time. Further, when a less number of control points are generated, the operation quantity can be reduced and the power consumption can be thereby reduced.

Further, when the number of the control points is controlled in response to the remaining battery level, the user can be notified of the remaining battery level through the provided image quality.

Further, according to the present invention, the number of the control points for determining the shape of the free curved surface/free curved line can be changed in response to how the rendering object appears to the user. The free curved surface/free curved line can be created based on the changed number of control points. Therefore, the free curved surface free curved line can be created achieving an optimum image quality while flexibly responding to the user's assessment on the rendering object. For example, when an object which moves a long distance in a short period of time and at a high speed is rendered, the free curved surface/free curved line is created using a reduced number of control points so that the operation quantity is controlled in the case of any object which can be hardly visually recognizable to the user. In reducing the number of the generated control points, the operation quantity can be reduced, which leads to the reduction of the power consumption, and a hardware resource can be used for processes other than the creation of the free curved surface/free curved line.

The rendering device and the rendering method according to the present invention, which is capable of controlling the number of the generated control points used for the creation of the free curved surface free curved line based on the system information and thereby creating the free curved surface/free curved line based on the operation quantity in compliance with the system statuses, is advantageous as a technology for creating the free curved surface or the free curved line within a given rendering renewal cycle.

The rendering device and the rendering method according to the present invention, which is capable of controlling the number of the generated control points used for the creation of the free curved surface/free curved line based on the rendering object information and thereby creating the free curved surface/free curved line based on the operation quantity in compliance with the statuses of the rendering object, is advantageous as the technology for creating the free curved surface or the free curved line within the given rendering renewal cycle.

The present invention is not necessarily limited to the embodiments so far described and can be differently modified and implemented within the scope of its technical idea.

1-14. (canceled)

15. A rendering device comprising:
an information acquiring unit for acquiring system information or rendering object information;
a control point generating section for setting a curved surface interpolating level serving to determine number of control points for creating a curved surface or a curved line based on the acquired information and thereby generating the control point in accordance with the curved surface interpolating level; and
a curved surface creating section for creating the curved surface based on the control point, wherein
an operation quantity for rendering the curved surface of a display object is dynamically changed based on the acquired information, wherein
the information acquiring unit is a rendering object information acquiring unit for acquiring the rendering object information,
the control point generating section sets the curved surface interpolating level serving to determine the number of the control points for creating the curved surface or the curved line based on the rendering object information and thereby generates the control point in accordance with the curved surface interpolating level,
the curved surface creating section creates the curved surface based on the control point, and
the operation quantity for rendering the curved surface of the display object is dynamically changed based on the rendering object information.

16. A rendering device as claimed in claim 15, wherein
the rendering object information acquiring unit comprises a moving speed information acquiring section for acquiring a moving speed of a rendering object, and the object display information is the moving speed of the rendering object.

17. A rendering device as claimed in claim 15, wherein
the rendering object information acquiring unit comprises a display area information acquiring section for acquiring a display area information of a rendering object, and the object display information is the display area information of the rendering object.

18. A rendering device as claimed in claim 15, wherein
the rendering object information acquiring unit comprises an object-of-attention distance information acquiring section for acquiring distance information indicating a distance between a rendering object and a previously determined object of attention, and the object display information is the distance information.

19. A rendering device as claimed in claim 15, wherein
the rendering object information acquiring unit comprises a rendering object numeral information acquiring section for acquiring numeral information of a rendering object, and the object display information is the numeral information of the rendering object.

20. A rendering device as claimed in claim 15, wherein
the rendering object information acquiring unit comprises a rendering object size information acquiring section for acquiring size information of a rendering object, and the object display information is the size information of the rendering object.

21. A rendering device as claimed in claim 15, wherein
the rendering object information acquiring unit comprises a displayed period information acquiring section for acquiring displayed period information of a rendering object, and the object display information is the displayed period information of the rendering object.

22. A rendering device as claimed in claim 15, wherein
the rendering object information acquiring unit comprises a display device image quality information acquiring section for acquiring an image quality of a display unit, and the object display information is the image quality information of a rendering object.

23. A rendering device as claimed in claim 15, wherein
the object information acquiring unit comprises at least two of a moving speed information acquiring section for acquiring a moving speed information of a rendering object, a display area information acquiring section for acquiring a display area information of the rendering object, an object-of-attention distance information acquiring section for acquiring distance information indicating a distance between the rendering object and a previously determined object of attention, a rendering object numeral information acquiring section for acquiring numeral information of the rendering object, a rendering object size information acquiring section for acquiring size information of the rendering object, a displayed period information acquiring section for acquiring displayed period information of the rendering object, and a display device image quality information acquiring section for acquiring an image quality of a display unit, and
the rendering object display information comprises at least two of the moving speed information of the rendering object, the display area information of the rendering object, the distance information indicating the distance between the rendering object and the previously determined object of attention, the numeral information of the rendering object, the size information of the rendering object, the displayed period information of the rendering object and the image quality information of the display unit.

24. A rendering device as claimed in claim 15, wherein
the curved surface interpolating level and the number of the control points are set depending on if the rendering object display information is higher or lower than a preciously set value.

25. A rendering device as claimed in claim 15, wherein
the operation quantity is changed in a phased manner in accordance with the rendering object display information.

26. A rendering device as claimed in claim 15, wherein
the operation quantity is determined by the curved surface interpolating level.

27. A rendering device as claimed in claim 15, wherein
the operation quantity is determined by the number of the control points.

28. A rendering device as claimed in claim 15, wherein
the operation quantity is determined by the curved surface interpolating level and the number of the control points.

29. A rendering device as claimed in claim 15, wherein
the rendering object information acquiring unit determines a representative point or a plurality of representative points for respective rendering objects, and the representative point is a center of gravity of a polygon shaped by all or a part of the control points generated by the control point generating section.

30. A rendering device as claimed in claim 15, wherein
the rendering object information acquiring unit determines a representative point or a plurality of representative points for respective rendering objects, and the representative point is a point whose average distance from all or a part of the control points generated by the control point generating section has a shortest length.

31. A rendering device as claimed in claim 15, wherein
the rendering object information acquiring unit determines a representative point or a plurality of representative points for respective rendering objects, and the representative point is selected under given conditions from the control points of all or a part of the control points generated by the control point generating section which can be also generated in the case of rendering a free curved surface/free curved line with a minimum precision.

32. A rendering device as claimed in claim 15, wherein
the rendering object information acquiring unit determines a representative point or a plurality of representative points for respective rendering objects, and the representative point is selected from a group comprising a center of gravity of a polygon shaped by all or a part of the control points generated by the control point generating section, a point whose average distance from all or a part of the control points generated by the control point generating section has a shortest length, and the control point being selected under given conditions from the control points of all or a part of the control points generated by the control point generating section which can be also generated in the case of rendering a free curved surface/free curved line with a minimum precision,
a linear distance which the representative point moves in a certain length of time is used as a moving distance, and a moving speed of a rendering object is obtained by dividing the moving distance by the certain length of time.

33. A rendering device as claimed in claim 15, wherein
an average value of linear distances which the control point moves in a certain length of time is used as a moving distance, and a moving speed of a rendering object is obtained by dividing the moving distance by the certain length of time.

34. A rendering device as claimed in claim 15, wherein
the rendering object information acquiring unit determines a representative point or a plurality of representative points for respective rendering objects, and the representative point is selected from a group comprising a center of gravity of a polygon shaped by all or a part of the control points generated by the control point generating section, a point whose average distance from all or a part of the control points generated by the control point generating section has a shortest length, and the control point being selected under given conditions from the control points of all or a part of the control points generated by the control point generating section which can be also generated in the case of rendering a free curved surface/free curved line with a minimum precision,
an average value of the curved surface interpolating levels of display areas to which the representative points of a rendering object belong is used as the curved surface interpolating level of an entirety of the rendering object.

35. A rendering device as claimed in claim 15, wherein
the rendering object information acquiring unit determines a representative point or a plurality of representative points for respective rendering objects, and the representative point is selected from a group comprising a center of gravity of a polygon shaped by all or a part of the control points generated by the control point generating section, a point whose average distance from all or a part of the control points generated by the control point generating section has a shortest length, and the control point being selected under given conditions from the control points of all or a part of the control points generated by the control point generating section which can be also generated in the case of rendering a free curved surface/free curved line with a minimum precision,
the curved surface interpolating level of a display area to which a largest number of representative points of a rendering object belong is used as the curved surface interpolating level of an entirety of the rendering object.

36. A rendering device as claimed in claim 15, wherein
the rendering object information acquiring unit determines a representative point or a plurality of representative points for respective rendering objects, and the representative point is selected from a group comprising a center of gravity of a polygon shaped by all or a part of the control points generated by the control point generating section, a point whose average distance from all or a part of the control points generated by the control point generating section has a shortest length, and the control point being selected under given conditions from the control points of all or a part of the control points generated by the control point generating section which can be also generated in the case of rendering a free curved surface/free curved line with a minimum precision,
the curved surface interpolating levels of display areas to which the representative points of a rendering object respectively belong are used as the curved surface interpolating levels with respect to the control points in close vicinity of the representative points, and the respective control points are thinned out by the control point generating section in accordance with the curved surface interpolating levels.

37. A rendering device as claimed in claim 15, wherein
the rendering object information acquiring unit determines a representative point or a plurality of representative points for respective rendering objects, and the representative point is selected from a group comprising a center of gravity of a polygon shaped by all or a part of the control points generated by the control point generating section, a point whose average distance from all or a part of the control points generated by the control point generating section has a shortest length, and the control point being selected under given conditions from the control points of all or a part of the control points generated by the control point generating section which can be also generated in the case of rendering a free curved surface/free curved line with a minimum precision,
a linear distance between two representative points selected under given conditions from the control points of a same rendering object of all or a part of the control points generated by the control point generating section which can be also generated in the case of rendering a free curved surface/free curved line with a minimum precision is used as a size information of the rendering object.

38. A rendering device as claimed in claim 18, wherein
the rendering object information acquiring unit determines a representative point or a plurality of representative points for respective rendering objects, and the representative point is selected from a group comprising a center of gravity of a polygon shaped by all or a part of the control points generated by the control point generating section, a point whose average distance from all or a part of the control points generated by the control point generating section has a shortest length, and the control point being selected under given conditions from the control points of all or a part of the control points generated by the control point generating section which can be also generated in the case of rendering a free curved surface/free curved line with a minimum precision,
when a linear distance between two representative points selected under given conditions from the control points of a same rendering object of all or a part of the control points generated by the control point generating section which can be also generated in the case of rendering a free curved surface/free curved line with a minimum precision satisfy given conditions, the rendering object is used as the object of attention.

39. A rendering device as claimed in claim 15, wherein
the rendering object information acquiring unit determines a representative point or a plurality of representative points for respective rendering objects, and the representative point is selected from a group comprising a center of gravity of a polygon shaped by all or a part of the control points generated by the control point generating section, a point whose average distance from all or a part of the control points generated by the control point generating section has a shortest length, and the control point being selected under given conditions from the control points of all or a part of the control points generated by the control point generating section which can be also generated in the case of rendering a free curved surface/free curved line with a minimum precision,
a count number of a counter for counting a representative point satisfying given conditions among the representative points is used as a size information of a rendering object.

40. A rendering device as claimed in claim 15, wherein
the rendering object information acquiring unit determines a representative point or a plurality of representative points for respective rendering objects, and the representative point is selected from a group comprising a center of gravity of a polygon shaped by all or a part of the control points generated by the control point generating section, a point whose average distance from all or a part of the control points generated by the control point generating section has a shortest length, and the control point being selected under given conditions from the control points of all or a part of the control points generated by the control point generating section which can be also generated in the case of rendering a free curved surface/free curved line with a minimum precision,
a numeral value obtained by a counter for counting during a period when the representative point is included in a display area for each certain screen renewal cycle is used as information of a displayed period in which the rendering object is displayed.

41-54. (canceled)

55. A rendering method comprising:
a step for acquiring system information or rendering object information;
a step for determining a curved surface interpolating level for creating a curved surface or a curved line based on the acquired information and thereby generating a control point a step for creating the curved surface based on the control point; and
a step for dynamically changing an operation quantity for rendering the curved surface of a display object based on the acquired information wherein
the rendering object information is acquired,
the curved surface interpolating level for creating the curved surface or the curved line is determined based on the rendering object information and the control point is thereby generated,
the curved surface is created based on the control point, and
the operation quantity for rendering the curved surface of the display object is dynamically changed based on the rendering object information.

56. A rendering method as claimed in claim 55, wherein
the rendering object display information is a moving speed of a rendering object.

57. A rendering method as claimed in claim 55, wherein
the rendering object display information is a display area of a rendering object.

58. A rendering method as claimed in claim 55, wherein
the rendering object display information is information indicating a distance between a rendering object and a previously determined object of attention.

59. A rendering method as claimed in claim 55, wherein
the rendering object display information is numeral information of a rendering object.

60. A rendering method as claimed in claim 55, wherein
the rendering object display information is size information of a rendering object.

61. A rendering method as claimed in claim 55, wherein
the rendering object display information is displayed period information of a rendering object.

62. A rendering method as claimed in claim 55, wherein
the rendering object display information is image quality information of a display unit.

63. A rendering method as claimed in claim 55, wherein
the rendering object display information comprises at least two of a moving speed information of a rendering object, a display area information of the rendering object, a information indicating a distance between the rendering object and a previously determined object of attention, a numeral information of the rendering object, a size information of the rendering object, a displayed period information of the rendering object and a image quality information of a display unit.

64. A rendering method as claimed in claim 55, wherein
the curved surface interpolating level and number of the control points are set depending on if the rendering object display information is higher or lower than a preciously set value.

65. A rendering method as claimed in claim 55, wherein
the operation quantity is changed in a phased manner in accordance with the rendering object display information.

66. A rendering method as claimed in claim 55, wherein
the operation quantity is determined by the curved surface interpolating level.

67. A rendering method as claimed in claim 55, wherein
the operation quantity is determined by number of the control points.

68. A rendering method as claimed in claim 55, wherein
the operation quantity is determined by the curved surface interpolating level and number of the control points.
